(19) United States
(12) Patent Application Publication
(10) Pub. No.: US 2026/0253473 A1
(43) Pub. Date: Aug. 27, 2026

(54) GAMING MACHINE, METHOD FOR PROVIDING GAME, AND STORAGE MEDIUM

(71) Applicant: Konami Gaming, Inc., Las Vegas, NV (US)

(72) Inventor: Hiraku KUDO, Kanagawa (JP)

(21) Appl. No.: 19/651,657

(22) Filed: Apr. 18, 2026

Related U.S. Application Data
(63) Continuation-in-part of application No. 19/336,250, filed on Sep. 22, 2025.

(30) Foreign Application Priority Data
Sep. 26, 2024 (JP) 2024-167613

(51) Int. Cl. G07F 17/32; G06F 7/58

(52) U.S. Cl. CPC G07F 17/3213; G06F 7/588; G07F 17/3262

(57) ABSTRACT

A gaming machine for displaying a computer-animated reel game is described herein. The gaming machine includes one or more processors programmed to execute an algorithm to display an animated sequence of computer-generated images of the computer-animated reel game on a display device GUI including the steps of initiating a free game selection animation sequence by rendering a free game selection screen including a player selectable free game icon displaying a first game feature notification icon indicating that an appearance of the special symbol may trigger a reveal boost game feature animation sequence, and a player selectable super free game icon displaying an inner symbol notification indicating that a predefined number of inner symbols will be added to the reels and a second game feature notification icon indicating that an appearance of the special symbol always triggers the reveal boost game feature animation sequence.

### CROSS-REFERENCE TO RELATED APPLICATION

This application is a continuation-in-part of U.S. Patent Application Serial No. 19/336,250, filed September 22, 2025, which claims the benefit of Japanese Patent Application No. 2024-167613 filed with the Japan Patent Office on September 26, 2024, the entire contents of which are hereby incorporated by reference.

### TECHNICAL FIELD

The present disclosure relates to a gaming machine, a gaming method, and a storage medium.

### BACKGROUND

U.S. Patent No. 10,169,956 discloses a gaming machine that provides a slot game. This gaming machine presents a first award and a second award to a player based on a game result of a base game, and causes the player to select either the first award or the second award. The first award is a first number of free games, and a first multiplier is applied to the game results thereof. The second award is a second number of free games, which is smaller than the first number, and a second multiplier, which is larger than the first multiplier, is applied to the game results thereof.

### SUMMARY

In the gaming machine described in U.S. Patent No. 10,169,956, although the free games provided by the first award and the second award differ in the number of free games and the magnitude of the multiplier for the game result, the content of the free games is the same. Therefore, whichever free game is provided, a player will have the same playing experience. For this reason, the player's expectation for the game may decrease according to the number of plays, and the motivation for the player to repeatedly play the game may be weakened. In view of such related art, an object of the present disclosure is to provide a game capable of realizing a game progression and/or game mechanics that sufficiently gives novel stimulation and excitement to a player. Note that "gameplay" as used in this specification is a general term for rules for game progression, a mechanism for generating a win, a system for determining an award amount, and the like. Furthermore, the term “game mechanics” as used in this specification refers to the rules, mechanisms, algorithms, systems, etc. that provide the gameplay to players.

A gaming machine according to one aspect of the present disclosure includes a display unit and a control unit connected to the display unit. The control unit is configured to provide a base game and a free game. The free game is triggered at least in the base game. The free game includes a first free game and a second free game. The first free game and the second free game have a same or corresponding game feature. The game feature is provided with a first probability in the first free game, and the game feature is provided with a second probability higher than the first probability in the second free game. In response to the free game being triggered, the control unit causes a player to select either the first free game or the second free game, and provides the free game selected by the player.

In this gaming machine, the game feature is provided with a first probability in the first free game, and the game feature is provided with a second probability higher than the first probability in the second free game. This gaming machine can provide the game feature with different probabilities for each free game. Therefore, the player can be made aware of the probability with which the game feature is provided, and can be made to play the game with an expectation that the feature will be triggered. At the same time, the player can have a different playing experience for each free game, and the results of the game can be further diversified. Thus, this gaming machine can provide a game capable of realizing a game progression and/or game mechanics that sufficiently gives novel stimulation and excitement to a player. Furthermore, by introducing a new index of the probability with which the game feature is provided, this gaming machine can encourage a player to think strategically when selecting a free game.

In one embodiment, the base game and the free game may be slot games, and the control unit may trigger the free game when a result of the base game or a result of the free game includes a trigger symbol. Such a gaming machine has a clear trigger condition for the free game, making it easier for the player to understand the progress of the game.

In one embodiment, the first probability may be less than 1.0, and the second probability may be 1.0. In such a gaming machine, the game feature is guaranteed to be applied in the second free game, which can encourage the player to think more strategically when selecting a free game. Note that the game feature being guaranteed to be applied is not limited to the game feature being guaranteed to be applied when the second free game is provided. For example, it includes a case where, in the first free game, the game feature is triggered with a certain probability when the game result satisfies a predetermined condition, whereas in the second free game, the trigger condition for the game feature is satisfied simply by the game result satisfying the predetermined condition.

In one embodiment, the base game may be a wagered game (a game provided for a fee), and the free game may be a non-wagered game (a game provided free of charge). Such a gaming machine can increase the expectation for the free game.

In one embodiment, the number of times the first free game is provided may be a first number of times, and the number of times the second free game is provided may be a second number of times that is smaller than the first number of times. Such a gaming machine can cause the player to consider not only the probability with which the game feature is provided but also the number of times the free game is provided when selecting a free game, and to consider the balance between the magnitude of the winning opportunity and the return. Therefore, it can encourage the player to think more strategically when selecting a free game.

In one embodiment, the control unit may display the number of times the free game is provided for the first free game and the second free game, together with the probabilities of the game feature being provided in each case, in a comparable form on the display unit, to encourage the player to select either the first free game or the second free game. Such a gaming machine can provide a situation that is easy for the player to consider when selecting a free game.

A method for providing a game according to another aspect of the present disclosure is a method for providing a game executed in a gaming machine including a display unit, and a control unit connected to the display unit, the control unit being configured to provide a base game and a free game, the free game being triggered at least in the base game, the free game including a first free game and a second free game, and the first free game and the second free game having a same or corresponding game feature, the method including the steps of: causing, by the control unit, a player to select either the first free game or the second free game in response to the free game being triggered; and providing, by the control unit, the free game selected by the player, wherein the game feature is provided with a first probability in the first free game, and the game feature is provided with a second probability higher than the first probability in the second free game. This method for providing a game produces the same effects as the gaming machine described above.

A program according to another aspect of the present disclosure is a program executed by a control unit in a gaming machine including a display unit, and a control unit connected to the display unit, the control unit being configured to provide a base game and a free game, the free game being triggered at least in the base game, the free game including a first free game and a second free game, and the first free game and the second free game having a same or corresponding game feature, the program causing the control unit to: cause a player to select either the first free game or the second free game in response to the free game being triggered; and provide the free game selected by the player, wherein the game feature is provided with a first probability in the first free game, and the game feature is provided with a second probability higher than the first probability in the second free game. This program produces the same effects as the gaming machine described above.

A gaming machine according to another aspect of the present disclosure includes a display unit and a control unit connected to the display unit. The control unit is configured to provide a base game and a free game, wherein the free game is triggered at least in the base game, the base game and the free game have a same or corresponding game feature, the game feature is provided with a first probability in the base game, and the game feature is provided with a second probability higher than the first probability in the free game.

In this gaming machine, the game feature is provided with a first probability in the base game, and the game feature is provided with a second probability higher than the first probability in the free game. This gaming machine can provide the game feature with different probabilities for the base game and the free game. Therefore, the player can be made aware of the probability with which the game feature is provided, and can be made to play the free game with an expectation that the feature will be triggered. At the same time, the player can have a different playing experience between the base game and the free game, and the results of the game can be further diversified. Thus, this gaming machine can provide a game capable of realizing a game progression and/or game mechanics that sufficiently gives novel stimulation and excitement to a player.

A method for providing a game according to another aspect of the present disclosure is a method for providing a game executed in a gaming machine including a display unit and a control unit connected to the display unit, wherein the control unit is configured to provide a base game and a free game, the free game is triggered at least in the base game, the base game and the free game have a same or corresponding game feature, the game feature is provided with a first probability in the base game, and the game feature is provided with a second probability higher than the first probability in the free game. This method for providing a game produces the same effects as the gaming machine described above.

A program according to another aspect of the present disclosure is a program executed by a control unit in a gaming machine including a display unit and a control unit connected to the display unit, and providing a base game and a free game, wherein the free game is triggered at least in the base game, and the base game and the free game have a same or corresponding game feature, the program causing the control unit to: provide the game feature with a first probability in the base game; and provide the game feature with a second probability higher than the first probability in the free game. This program produces the same effects as the gaming machine described above.

In one aspect of the present invention, a gaming machine for displaying a computer-animated reel game is provided. The gaming machine includes a gaming cabinet, a display device mounted to the gaming cabinet and including a graphical user interface (GUI) display screen displaying computer-generated images thereon, and a control unit including a random number generator and one or more processors operably coupled to the display device. The one or more processors are programmed to execute an algorithm to display an animated sequence of computer-generated images of the computer-animated reel game on the display device GUI including the steps of rendering a game screen on the display device GUI including a grid having a plurality of cells arranged in a three row by five column (3x5) matrix, rendering a plurality of reels within the grid displaying a plurality of game symbols including a trigger symbol and a special symbol, each reel being displayed within a corresponding column, and initiating a spin of the reel game by animating the plurality of reels to spin and stop to display the game symbols within the grid including a plurality of trigger symbols. The one or more processors then initiate a free game selection animation sequence by determining a number of free games based on a number of trigger symbols being displayed within the grid with the reels stopped, accessing a super free game data lookup table to determine a number of super free games associated with the determined number of free games, and rendering a free game selection screen including a player selectable free game icon and a player selectable super free game icon. The player selectable free game icon displays the determined number of free games and a first game feature notification icon indicating that an appearance of the special symbol may trigger a reveal boost game feature animation sequence. The player selectable super free game icon displays the determined number of super free games, an inner symbol notification indicating that a predefined number of inner symbols will be added to the reels, and a second game feature notification icon indicating that an appearance of the special symbol always triggers the reveal boost game feature animation sequence.

In another aspect of the present invention, a method of operating a gaming machine for displaying a computer-animated reel game is provided. The gaming machine includes a gaming cabinet, a display device mounted to the cabinet and including a graphical user interface (GUI) display screen displaying computer-generated images thereon, and a control unit including a random number generator and one or more processors coupled to the display device. The method includes the one or more processors performing an algorithm to display an animated sequence of computer-generated images of the computer-animated reel game on the display device GUI including the steps of rendering a game screen on the display device GUI including a grid having a plurality of cells arranged in a three row by five column (3x5) matrix, rendering a plurality of reels within the grid displaying a plurality of game symbols including a trigger symbol and a special symbol, each reel being displayed within a corresponding column, and initiating a spin of the reel game by animating the plurality of reels to spin and stop to display the game symbols within the grid including a plurality of trigger symbols. The one or more processors then initiate a free game selection animation sequence by determining a number of free games based on a number of trigger symbols being displayed within the grid with the reels stopped, accessing a super free game data lookup table to determine a number of super free games associated with the determined number of free games, and rendering a free game selection screen including a player selectable free game icon and a player selectable super free game icon. The player selectable free game icon displays the determined number of free games and a first game feature notification icon indicating that an appearance of the special symbol may trigger a reveal boost game feature animation sequence. The player selectable super free game icon displays the determined number of super free games, an inner symbol notification indicating that a predefined number of inner symbols will be added to the reels, and a second game feature notification icon indicating that an appearance of the special symbol always triggers the reveal boost game feature animation sequence.

In a further aspect of the present invention, a non-transitory computer-readable storage media having computer-executable instructions embodied thereon to operate a gaming machine for displaying a computer-animated reel game is provided. The gaming machine includes a gaming cabinet, a display device mounted to the cabinet and including a graphical user interface (GUI) display screen displaying computer-generated images thereon, and a control unit including a random number generator and one or more processors coupled to the display device. The computer-executable instructions cause the one or more processors to perform an algorithm to display an animated sequence of computer-generated images of the computer-animated reel game on the display device GUI including the steps of rendering a game screen on the display device GUI including a grid having a plurality of cells arranged in a three row by five column (3x5) matrix, rendering a plurality of reels within the grid displaying a plurality of game symbols including a trigger symbol and a special symbol, each reel being displayed within a corresponding column, and initiating a spin of the reel game by animating the plurality of reels to spin and stop to display the game symbols within the grid including a plurality of trigger symbols. The one or more processors then initiate a free game selection animation sequence by determining a number of free games based on a number of trigger symbols being displayed within the grid with the reels stopped, accessing a super free game data lookup table to determine a number of super free games associated with the determined number of free games, and rendering a free game selection screen including a player selectable free game icon and a player selectable super free game icon. The player selectable free game icon displays the determined number of free games and a first game feature notification icon indicating that an appearance of the special symbol may trigger a reveal boost game feature animation sequence. The player selectable super free game icon displays the determined number of super free games, an inner symbol notification indicating that a predefined number of inner symbols will be added to the reels, and a second game feature notification icon indicating that an appearance of the special symbol always triggers the reveal boost game feature animation sequence.

According to the present disclosure, a gaming machine, a method for providing a game, and a program can be provided that are capable of providing a game that can realize a game progression and/or game mechanics that sufficiently gives novel stimulation and excitement to a player. Note that the present disclosure is directed to a technical improvement for computer-implemented gaming machines. Specifically, it addresses the technical problem of how to present complex game state transitions and outcomes to a player in a clear and intuitive manner on a graphical user interface (GUI). The disclosed solution, involving a specific, ordered combination of steps performed by a processor, such as rendering, animating, and modifying graphical elements, improves the functioning of the computer itself by enhancing the human-machine interface and providing dynamic visual feedback that cannot be replicated by mental steps or with pen and paper.

### BRIEF DESCRIPTION OF THE DRAWINGS

FIG. 1 is a perspective view illustrating an example of a gaming machine according to an embodiment.

FIG. 2 is a block diagram showing an example of the configuration of the gaming machine shown in FIG. 1.

FIG. 3 is a schematic diagram of a display area of the gaming machine of FIG. 1.

FIG. 4 is a diagram illustrating an example of a virtual reel strip.

FIG. 5 is a diagram illustrating an example of a symbol.

FIG. 6 is a diagram illustrating a relationship between a base game and a free game.

FIG. 7 is a diagram illustrating an example of a screen for receiving a player's selection.

FIG. 8 is a directory configuration diagram and a block diagram showing programs and data stored in the memory shown in FIG. 2.

FIG. 9 is a block diagram of a system for a gaming machine.

FIG. 10 is a block diagram of the game application program of FIG. 9.

FIG. 11 is a block diagram of the system application program shown in FIG. 9.

FIG. 12 is a flowchart for explaining the operation of the gaming machine.

FIG. 13 is a flowchart for explaining the operation of the gaming machine.

FIG. 14 is a flowchart for explaining the operation of the gaming machine.

FIG. 15 is a diagram illustrating another relationship between a base game and a free game.

FIG. 16 is an illustration of exemplary data lookup table that may be used when executing the algorithm shown in FIGS. 12-15.

FIGS. 17-20 are exemplary game screens of a computer-animated reel game illustrating a free game selection animation sequence displayed when executing the algorithm shown in FIGS. 12-15.

FIGS. 21-32 are exemplary game screens of a computer-animated reel game illustrating a super free game animation sequence displayed when executing the algorithm shown in FIGS. 12-15.

FIGS. 33-41 are exemplary game screens of a computer-animated reel game illustrating a free game animation sequence displayed when executing the algorithm shown in FIGS. 12-15.

Corresponding reference characters indicate corresponding parts throughout the drawings.

### DETAILED DESCRIPTION

Hereinafter, a gaming machine according to an embodiment will be described with reference to the accompanying drawings. In the drawings, the same or corresponding portions are denoted by the same reference numerals, and redundant description is omitted.

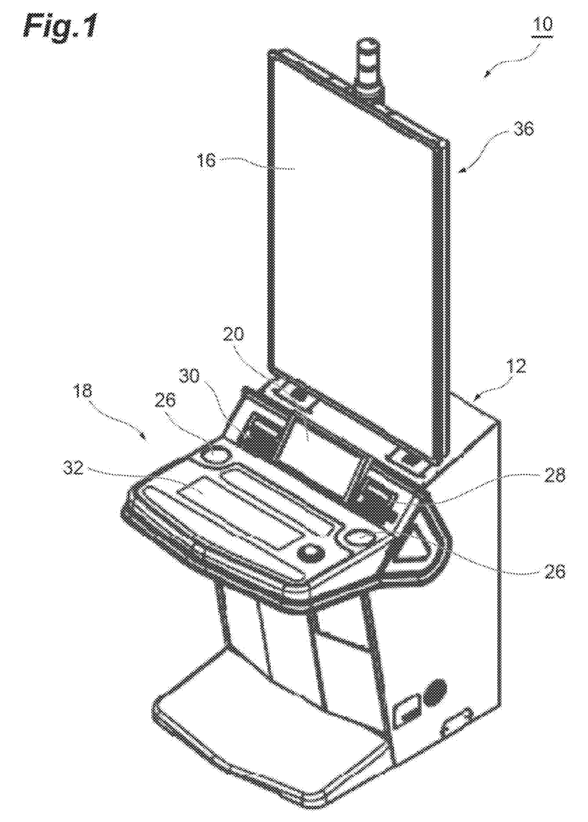

FIG. 1 is a perspective view illustrating an example of a gaming machine according to an embodiment. Here, the gaming machine is a device that receives a wager such as cash, medals, or tokens from a player, starts a game, and pays a prize, an award, or a payout to the player according to a randomly determined game result. Such a gaming machine is designed and manufactured in accordance with local regulations, and is installed as a device in a licensed facility such as a casino after obtaining authorization by an authorization agency. The gaming machine 10 shown in FIG. 1 may receive a predetermined game value from the player, generate a game result, and provide a payout to the player in response to the game result and a pay table. The gaming machine 10 provides a video slot game as an example. The video slot game includes, for example, a base game and a free game. The base game and the free game are provided when a predetermined condition is satisfied. In the base game and the free game, symbols displayed in the display region constitute a game result (such as a combination of symbols), and a winning is determined.

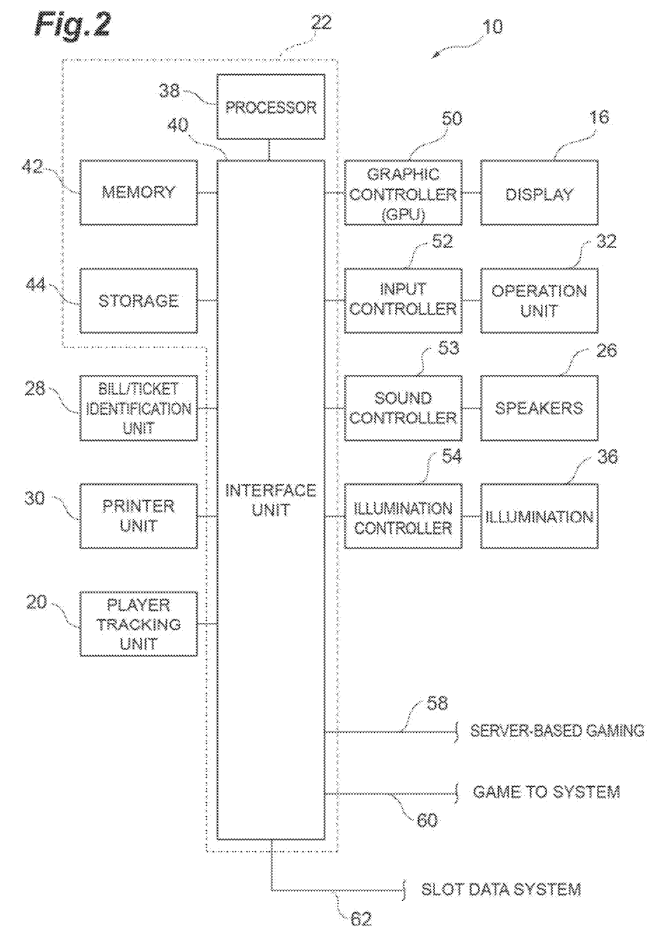

As shown in FIG. 1, the gaming machine 10 includes a display 16 (an example of a display unit) and a cabinet 12. The cabinet 12 also houses a control unit 22 (see FIG. 2) for controlling the components of the gaming machine 10.

The display 16 is a flat panel display device such as a liquid crystal display device or an organic EL display device. The display 16 is controlled via the control unit 22 and includes a graphical user interface (GUI) display screen displaying computer-generated images thereon to provide a game screen to the player. An illumination 36 may be provided around the display 16 to provide decorative lighting.

The cabinet 12 is disposed below the display 16. A control panel 18 is provided on the front surface of the cabinet 12 so as to project forward. The control panel 18 is provided with a player tracking unit 20, speakers 26, a bill/ticket identification unit 28, a printer unit 30, and an operation unit 32.

The player tracking unit 20 includes a card reader for recognizing a player identification card, a display for presenting data to the player, and a keypad for receiving input by the player. The player tracking unit 20 cooperates with the control unit 22 or an external system to read information recorded on the player identification card inserted into the card reader by the player and display the information and/or information acquired by communicating with the external system on a display. Furthermore, input from the player is received by the keypad, the display is changed according to the input, and communication with an external system is performed as necessary.

The speakers 26 are provided on the left and right of the control panel 18. The speakers 26 are controlled via the control unit 22 to provide sound to the player.

The bill/ticket identification unit 28 may be housed in the cabinet 12 with the insertion opening exposed through which the bill/ticket is inserted. An identification part for identifying bill/ticket by various sensors is provided inside the insertion port. A bill/ticket storage part is provided on the output side of the identification part. The bill/ticket identification unit 28 accepts bill/tickets (including vouchers and coupons) that are the gaming value, identifies them as the gaming value, and notifies the control unit 22.

The printer unit 30 may be accommodated in the cabinet 12 in a state where a ticket output port through which the ticket is output is exposed. A printing part for printing predetermined information on a printing paper is provided inside the ticket output port, and a housing part for housing the printing paper is provided on the paper inlet side of the printing part. The printer unit 30, under control of the control unit 22, prints information on paper and outputs a ticket from the gaming machine 10 according to credit payout processing. The output ticket may be inserted into the bill/ticket identification unit 28 of another gaming machine to use the payout credit for game play, or may be exchanged for cash by a kiosk terminal inside of the casino or casino cage.

The operation unit 32 receives an operation of the player. The operation unit 32 includes a group of buttons for receiving various instructions from the player on the gaming machine 10. For example, the operation unit 32 may include a group of a spin button and setting buttons. The spin button receives an instruction to start an instance of a game (start rotation of reel). The group of setting buttons includes a group of bet buttons and the like, such as a cash-out button. The group of bet buttons receives an instruction operation related to a credit amount of a bet (bet amount) from a player. The cash-out button receives an instruction operation for instructing payout of credit accumulated in the gaming machine 10.

FIG. 2 is a block diagram illustrating an example of the configuration of a gaming machine. The gaming machine 10 includes the control unit 22. The control unit 22 includes a central processing unit (CPU) 38 that includes one or more processors constituting the control unit 22, an interface unit 40, a memory 42 (an example of a storage unit), a storage 44 (an example of a storage unit), and the like. The control unit 22 may be housed inside the cabinet 12 as a control board. The control unit 22 is configured to be able to communicate with each unit via the interface unit 40, and controls the operation of each unit by executing a program recorded in the memory 42 or the storage 44 of CPU 38 to provide a game to the player.

The interface unit 40 includes a chipset that provides communication functions for CPU 38, such as a memory bus connected to the CPU 38, various expansion buses, a serial interface, a universal serial bus (USB) interface, an Ethernet (registered trademark) interface, and the like.

The memory 42 may include a random-access memory (RAM) that is a volatile storage medium, a read only memory (ROM) that is a nonvolatile storage medium, and an electrically erasable programmable read-only memory (EEPROM) that is a rewritable nonvolatile storage medium. The storage 44 provides the control unit 22 with a function as an external storage device, and can use a reader such as a memory card and a magneto-optical disk which are removable storage media, and can also use a hard disk.

The bill/ticket identification unit 28, the printer unit 30, a player tracking unit 20, a graphics controller (GPU: Graphics Processing Unit) 50, an input controller 52, a sound controller 53, and an illumination controller 54 are connected to the interface unit 40. The graphics controller 50, the input controller 52, the sound controller 53, and the illumination controller 54 may be housed inside cabinet 12 as control boards.

The control unit 22 is connected to the display 16 via the graphics controller 50. The control unit 22 is connected to the operation unit 32 via the input controller 52. The control unit 22 is connected to the illumination 36 via the illumination controller 54.

The control unit 22 controls each unit by executing programs stored in the memory 42 and the storage 44, and provides the game to the player. Here, for example, the program and data of the operating system and subsystem providing basic functions of the control unit 22 may be stored in the EEPROM of the memory 42, and the program and data of the application providing the game may be stored in the storage 44. According to such a configuration, the game can be easily changed or updated by exchanging the storage 44. Furthermore, the control unit 22 may have a multiprocessor configuration including a plurality of CPUs.

Hereinafter, each block connected to the control unit 22 will be described. The bill/ticket identification unit 28 accepts the bill/ticket at the insertion port and notifies the control unit 22 of identification information corresponding to the type of bills or payout processing of credit. The control unit 22 increases the credit amount usable in the game according to the notified contents. The printer unit 30 prints information corresponding to payout processing of credit from the gaming machine 10 on a ticket and outputs it under the control of the control unit 22 which receives the operation of a cash-out button included in the operation unit 32.

The player tracking unit 20 cooperates with the control unit 22 to transmit and receive player information and the like to and from the casino management system. The graphics controller 50 controls the display 16 under control of the control unit 22 to display a display image including various graphics data. The sound controller 53 drives the speakers 26 under the control of the control unit 22 to provide various sounds such as announcements, sound effects, BGM and the like. The illumination controller 54 performs lighting control of the illumination 36 under the control of the control unit 22.

The interface unit 40 includes various communication interfaces for communicating with the outside of the gaming machine 10. The interface unit 40 may communicate with external networks by Ethernet 58, 60 and a serial interface 62, as examples. FIG. 2 shows an example of communication with other gaming machines 10, a known server-side gaming network (Server-Based gaming), a G2S network (Game to System), and a slot information system (Slot Data System).

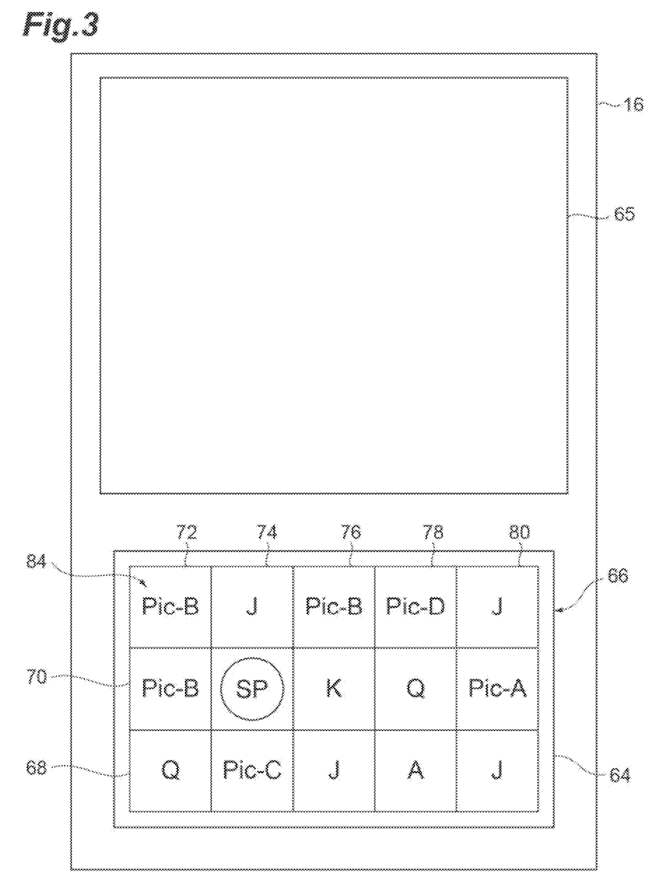

FIG. 3 is a schematic diagram of a display area of the gaming machine of FIG. 1. As shown in FIG. 3, a game screen is displayed in the display region of the display 16 by the control unit 22 executing a predetermined program. The game screen includes a symbol display region 64 for displaying a slot game. The symbol display region 64 is displayed in the lower region of the game screen as an example. Above the symbol display region 64, a region 65 is provided for displaying information related to the game and the like.

The symbol display region 64 includes a grid 68 capable of displaying symbols. By using such a display region, the gaming machine 10 operates as a slot machine that performs a winning determination according to a combination of symbols displayed on the grid 68 in the symbol display region 64 and provides a payout.

The display 16 displays a plurality of symbols in the grid 68. The grid 68 includes a plurality of rows and columns. The grid 68 is constituted by a plurality of cells 70 which are stop positions of symbols. FIG. 3 illustrates a game screen including a plurality of cells arranged in a 5×3 grid pattern (matrix pattern). The number of columns and the number of rows of the grid are not particularly limited, and may be another configuration such as 5×4, 3-4-4-4-3, 6×3, 6×4,or 3-3-3-5-5, or may be a configuration that increases or decreases according to the game progress and/or the bet amount. One symbol is stopped and displayed on each of a plurality of the cells 70 in the symbol display region 64.

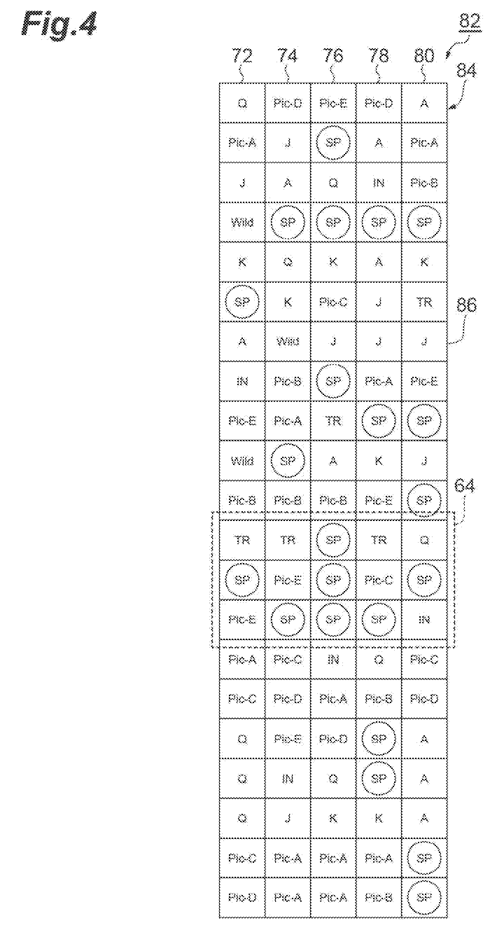

A symbol arranged in each of the plurality of cells 70 is determined by using a virtual reel strip for displaying a virtual reel 66. Hereinafter, the virtual reel 66 is also simply referred to as a reel. FIG. 4 is a diagram illustrating an example of a virtual reel set in a base game. The virtual reel set includes a plurality of virtual reel strips, and the virtual reel strip includes symbol arrangements indicating the order of symbols displayed in the symbol display region 64. On each cell 70 of the grid 68 shown in FIG. 3, symbols are displayed based on symbol arrangements of the virtual reel 66 including virtual reel strips 72, 74, 76, 78, and 80 which form a virtual reel set 82. That is, the cells 70 of the grid 68 correspond to the virtual reel strips 72 to 80 by column, and the symbols arranged in predetermined parts of each virtual reel strip 72 to 80 are displayed. Furthermore, by moving (scrolling or spinning) each symbol by column based on the symbol arrangement of the virtual reel strips 72 to 80, the symbols displayed in the cells 70 of the grid 68 change, and by stopping the movement (scrolling or spinning) by columns, the symbols are stopped. Here, the virtual reel strips 72 to 80 are data, and the control unit 22 uses a program included in the memory 42 or the storage 44, and data showing the symbol arrangement (i.e., the order of symbols on each reel strip) regulated by each cell column. The virtual reel set 82 is a general term for such virtual reel strips 72 to 80.

The virtual reel strips 72 to 80 illustrated in FIG. 4 are constituted by symbols 84 in each symbol position 86, and these symbols are arranged in an order defined for each reel. The number of symbols forming the virtual reel strips 72 to 80 is not limited thereto, and may be a desired number. The number of symbols forming the virtual reel strips 72 to 80 may be the same or may be different from each other.

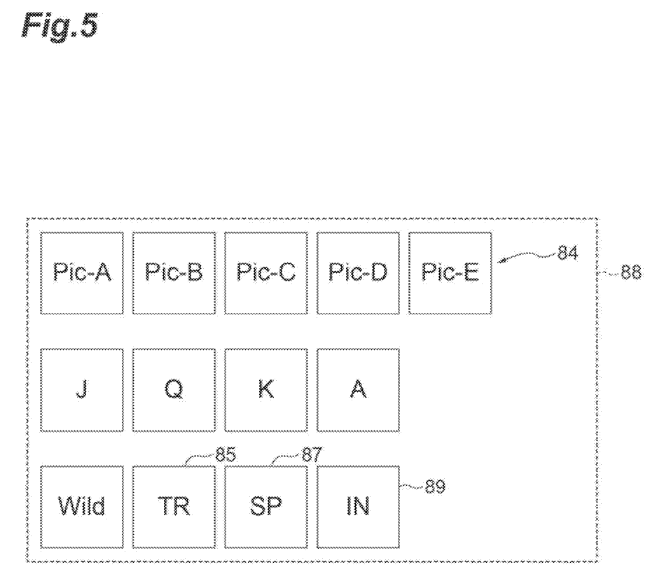

FIG. 5 is a detail of the symbols 84 shown in FIG. 4. Each of the virtual reel strips 72 to 80 includes symbols selected from a symbol set 88 of various symbols 84 shown in FIG. 5. The symbol set 88 includes card symbols ("J", "Q", "K", and "A") imitating playing cards as regular symbols, and picture symbols ("Pic-A", "Pic-B", "Pic-C", "Pic-D", and "Pic-E") indicating a person, animal/plant, object, treasure, or wealth.

The symbol set 88 includes a trigger symbol 85 ("TR"). The trigger symbol 85 is a symbol that triggers a free game in response to the appearance of a predetermined number of symbols when a winning combination is determined.

The symbol set 88 may include a special symbol 87 ("SP") and an inner symbol 89 ("IN"). The special symbol 87 is a symbol used in a game feature of a free game described later. The inner symbol 89 is a symbol that is converted into one of the symbols included in the pay table after the reels stop.

The symbol set 88 may include a wild symbol ("Wild") that is substituted as another symbol when a winning combination is determined. The symbol set 88 may include a jackpot symbol associated with a jackpot tier (rank). The jackpot tier is a level corresponding to the amount of the winning award, such as MINI, MAJOR, MAXI, MEGA, or GRAND.

A plurality of virtual reel sets may be prepared according to the game content. For example, the virtual reel set used in the base game and the virtual reel set used in the free game may be the same or different. The virtual reel set in the free game may include more picture symbols, wild symbols, trigger symbols 85, special symbols 87, and inner symbols 89 than the virtual reel set in the base game. In this way, it is possible to increase the winning probability or expected value during the free game, and it is possible to provide the player with a valuable free game.

A payline is set in the symbol display region 64. The payline is set, for example, to extend from a cell in the leftmost column to the rightmost column. An example of a payline can be composed of any cell in the leftmost column, any cell in the second column from the left, any cell in the third column from the left, any cell in the fourth column from the left, and any cell in the fifth column from the left (the rightmost column). In a 5x3 matrix, 243 types (3 to the power of 5) of paylines can be set, but 40 or 50 types of these paylines may be set.

The gaming machine 10 provides two types of games: a base game (also referred to as a main game or a normal game) provided for a fee, and a special game provided when a predetermined trigger condition is satisfied. The special game is a free game and is provided free of charge. That is, the free game is provided without consuming game value. The free game is triggered at least in the base game. The free game may be triggered when a result of the base game or a result of the free game includes a trigger symbol 85. The number of times the free game is provided may be changed according to the number of trigger symbols 85 included in the game result.

In the base game and the special game, a combination of symbols displayed in the symbol display region 64 among the symbol arrangement as a game result is subject to win determination. The control unit 22 starts the game and randomly determines the stopping position of each of the virtual reel strips 72 to 80. The virtual reel strips 72 to 80 displayed on the display 16 move (scroll or spin) from the current position and stop based on the stopping position to represent the game result. Therefore, in the display 16 or the grid 68, the symbols included in the virtual reel strips 72 to 80 change in accordance with continuous movement (scrolling or spinning) of the virtual reel strips 72 to 80 in the vertical direction of the symbol display region 64, and are displayed such that one symbol is stopped in one cell 70 according to the order of the symbols defined in the virtual reel strips 72 to 80.

The control unit 22 may be configured to change a plurality of symbols displayed on the display 16 by the above-described method in accordance with the operation of the player received by the operation unit 32, stop the symbols in a predetermined order, and provide a payout in accordance with the combination of symbols stopped in the symbol display region 64.

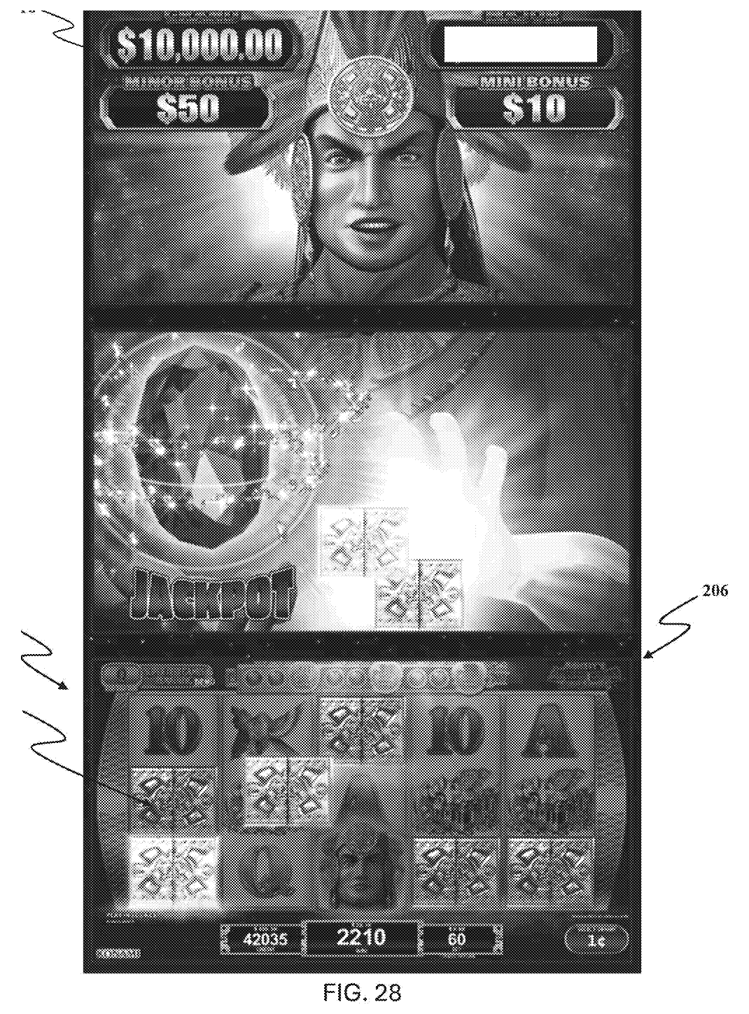

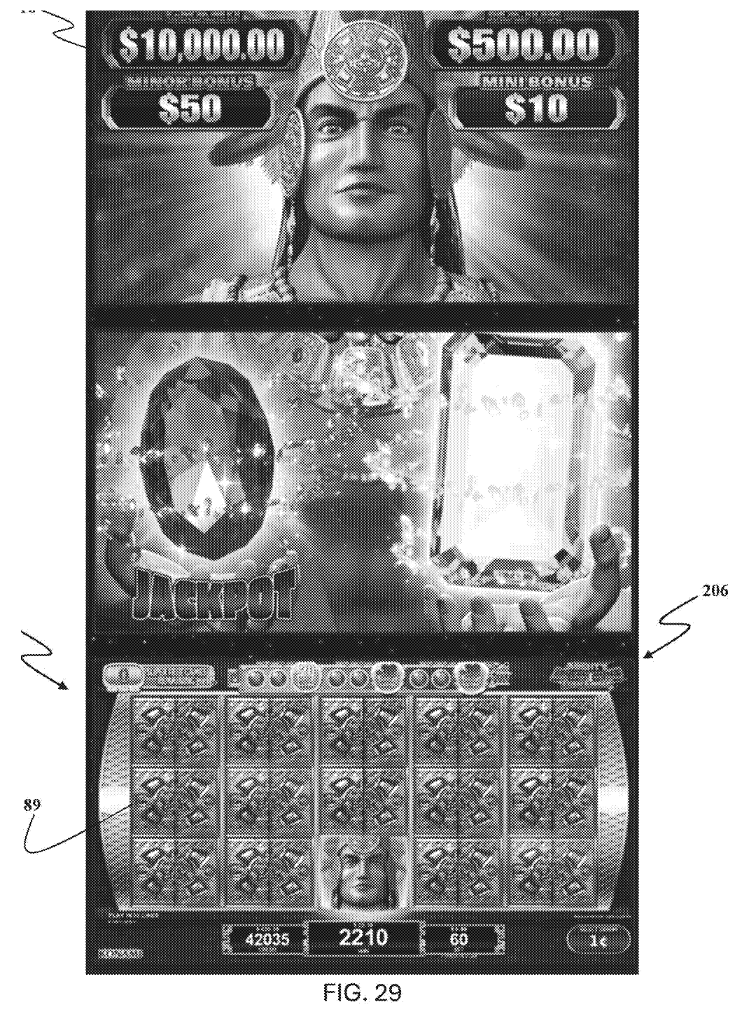

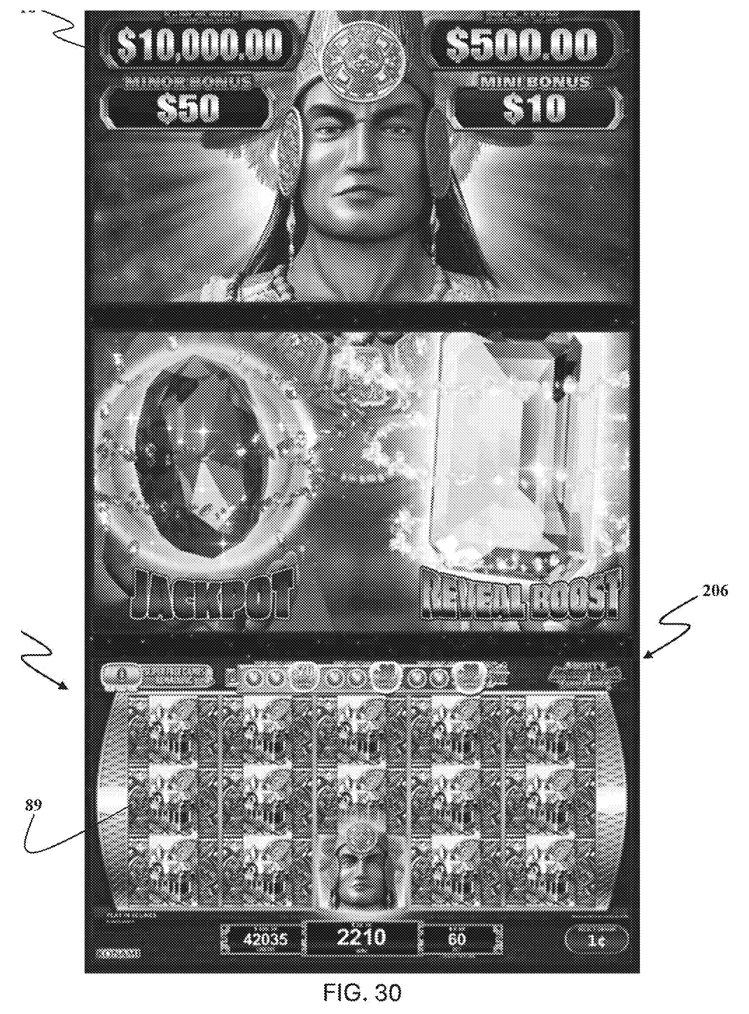

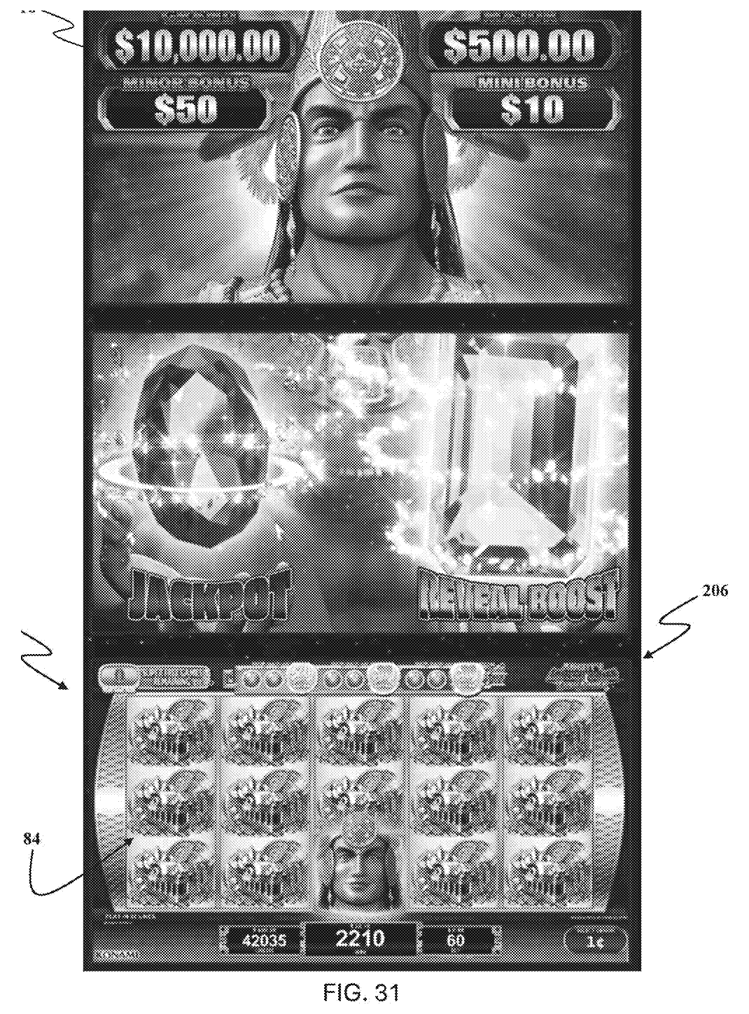

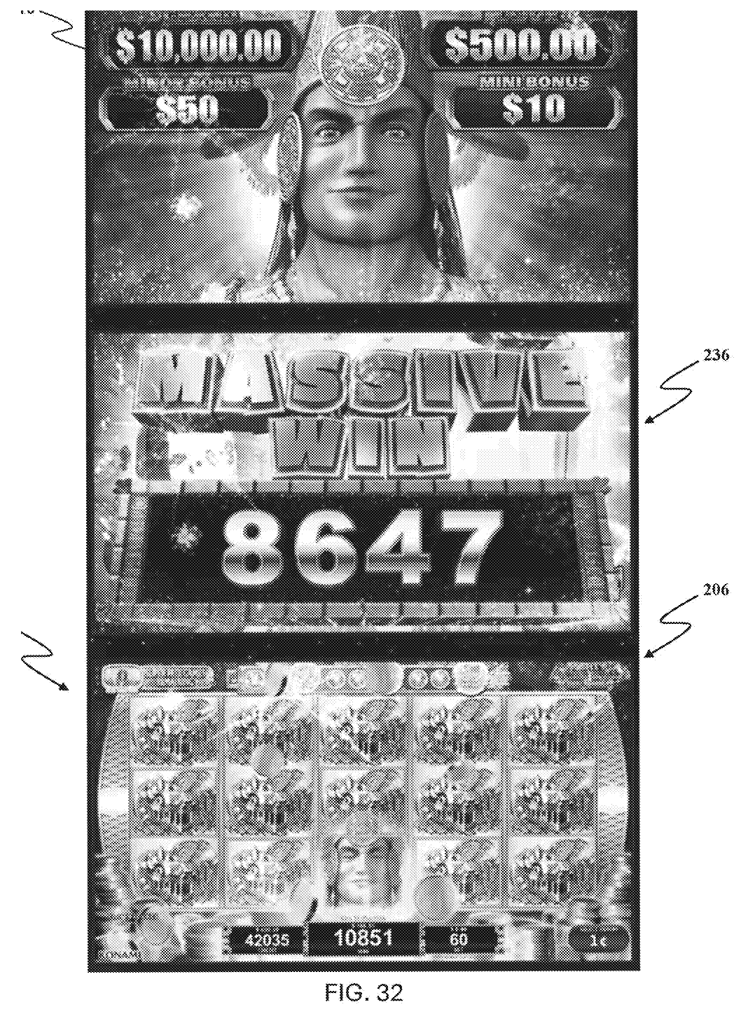

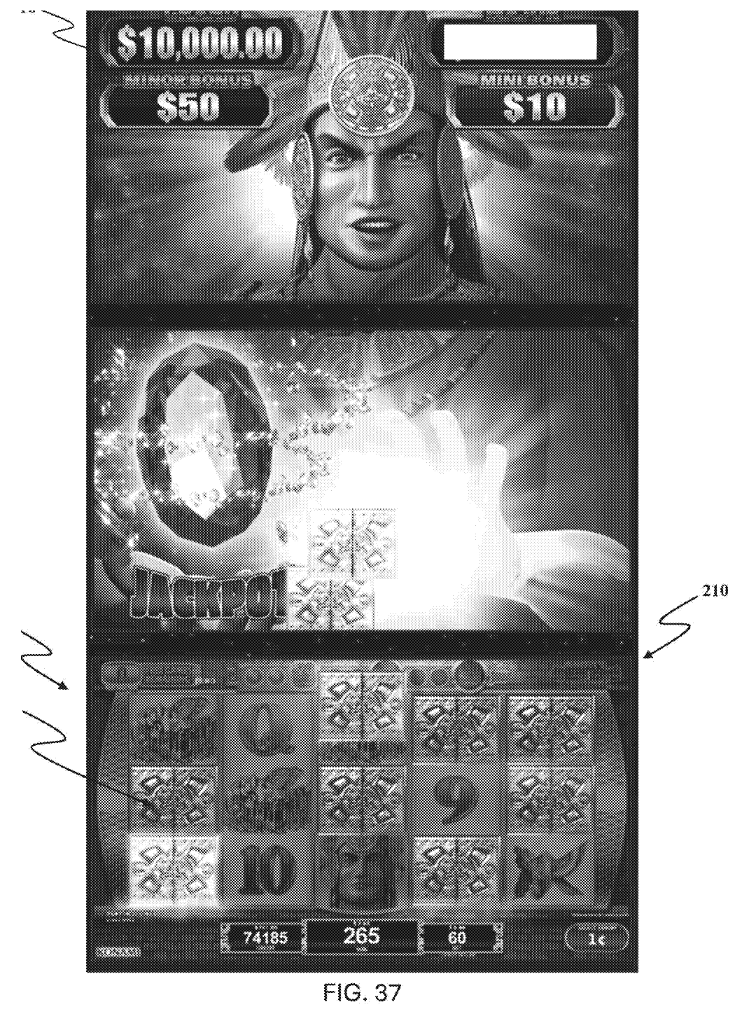

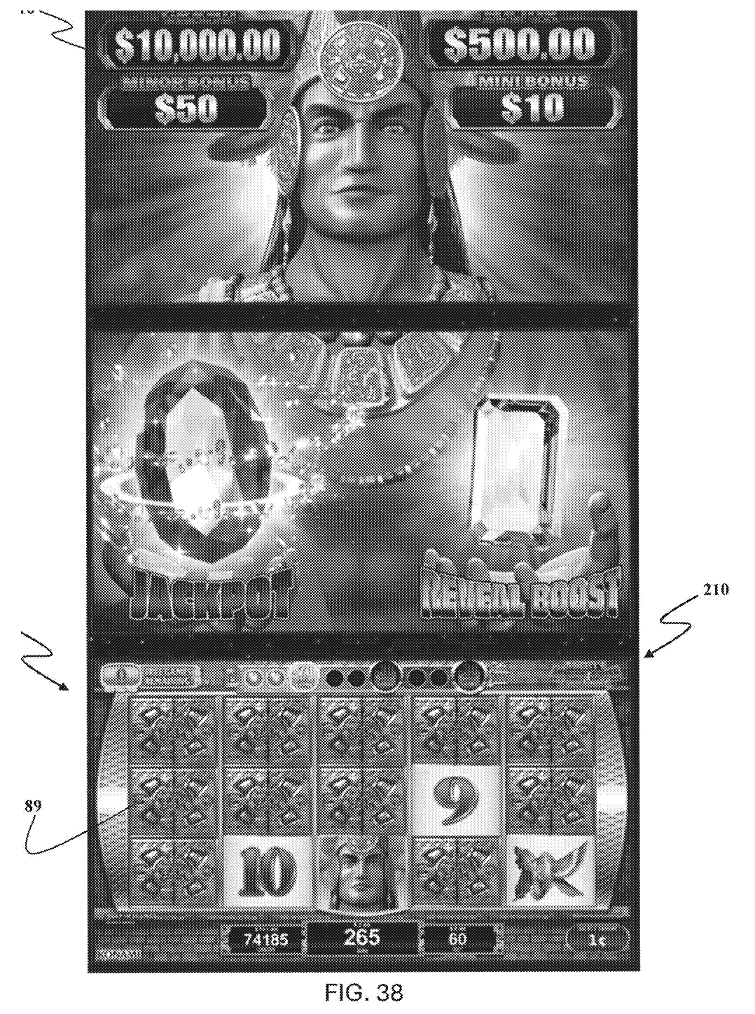

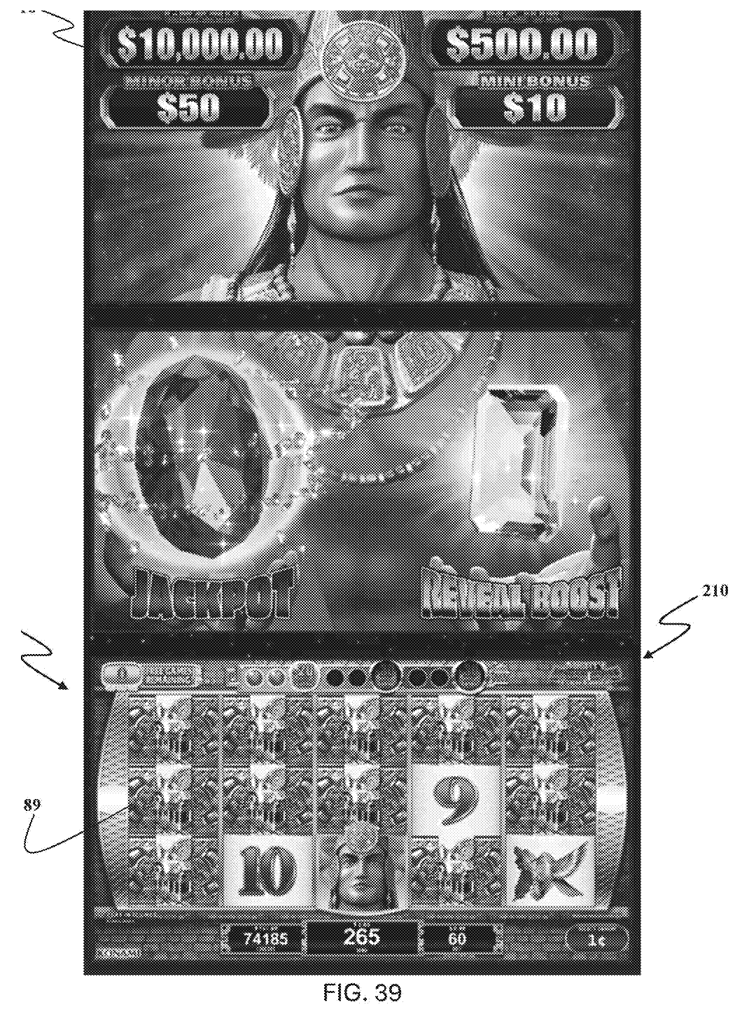

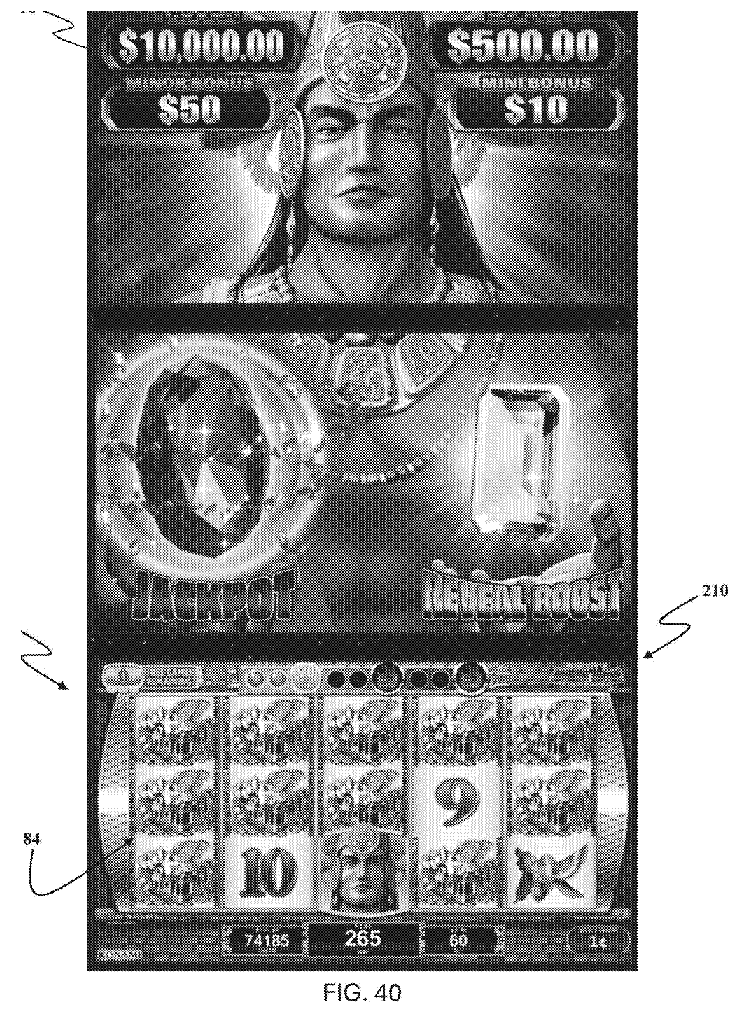

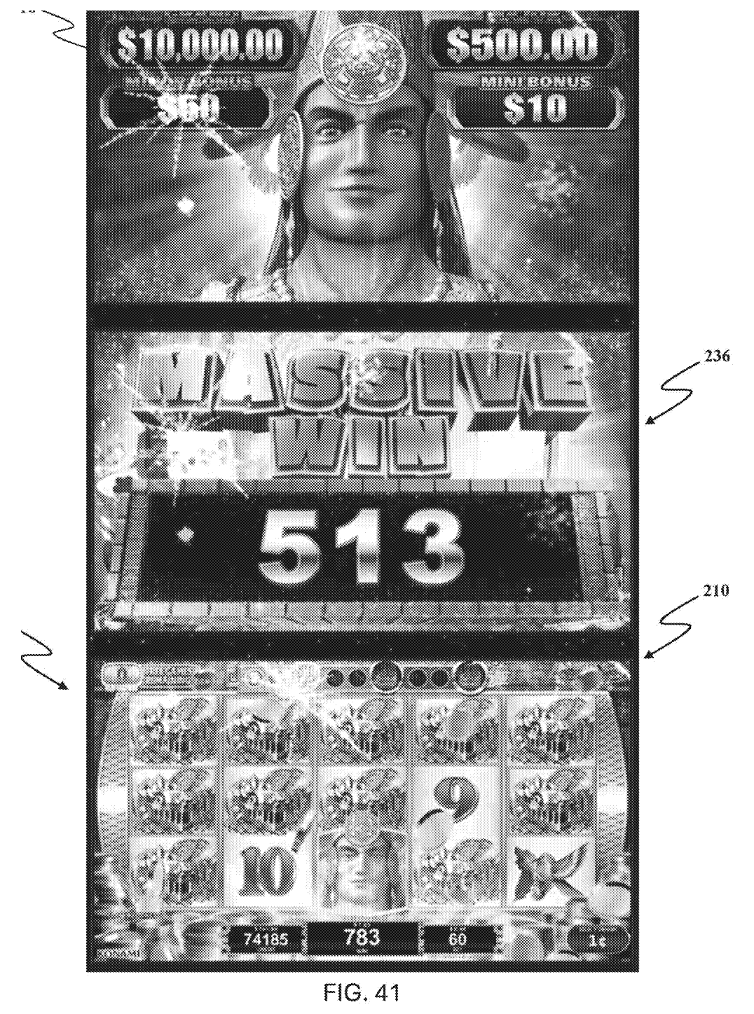

The control unit 22 provides a game feature when a predetermined condition is satisfied in the base game or the free game. For example, the game feature may include a reveal boost game feature animation sequence 208 (shown in FIGS. 28-32 and 36-41) that replaces some symbols in the symbol combination with inner symbols 89 in the symbol combination displayed as the game result. Since the inner symbol 89 is converted into one of the symbols included in the pay table, the game feature can increase the number of the symbols included in the game result, thereby increasing the probability that a win is formed. The game feature is not limited to the one described above, and may be to add a trigger symbol 85, change a symbol, duplicate a symbol, insert a special symbol 87, provide a multiplier, increase the number of rows and/or columns forming the grid 68, provide a jackpot payment, or enhance the virtual reel strip. The enhancement of the virtual reel strip is realized, for example, by removing card symbols from the virtual reel strip or adding inner symbols 89 to the virtual reel strip. The game feature may also be applied before the game result is displayed.

The control unit 22 may provide a same or corresponding game feature in the base game and the free game. A corresponding game feature means a game feature that is basically related to the same mechanism or mechanics, but has a difference in degree or extent, such as a different number of symbols to be added or a difference in the way the virtual reel strip is enhanced, or has another mechanism or mechanics added. For example, a game feature that adds a wild symbol may be provided in the base game, and a game feature that adds a multiplier wild symbol, which is a wild symbol with a multiplier function, may be provided in the free game.

The control unit 22 may set the activation condition for the game feature to be the same or different in the base game and the free game. The activation condition may be that a predetermined symbol is included in the game result, or it may be activated with a certain probability when a predetermined symbol is included in the game result. By introducing such a concept of probability, it is possible to prepare free games with different activation probabilities. For example, a first free game in which a game feature is provided with a first probability and a second free game in which a same or corresponding game feature is provided with a second probability can be prepared. Different probabilities are set for the first probability and the second probability. The second probability may be set higher than the first probability. For example, the first probability may be less than 1.0, and the second probability may be 1.0. In this case, in the first free game, even if a predetermined symbol is included in the game result, the game feature is not necessarily activated, so the inclusion of a predetermined symbol in the game result means that an opportunity to activate the game feature has been acquired. On the other hand, in the second free game, when a predetermined symbol is included in the game result, the game feature is always activated, so the inclusion of a predetermined symbol in the game result satisfies the activation condition for the game feature.

The control unit 22 may set an activation condition for a game feature that is applicable only to the free game. Since a free game is generally provided multiple times, a condition that can be achieved in multiple free games can be set as the activation condition for the game feature. For example, special symbols 87 that appear in the result of the free game may be collected, and the collected number may be held during the free game, so that the game feature may be activated according to the total number of collected special symbols 87. In this case, a game feature that enhances the virtual reel strip in stages according to the total number of collected special symbols 87 can be provided.

The control unit 22 may be configured to cause a player to select either the first free game or the second free game described above in response to the free game being triggered, and to provide the free game selected by the player.

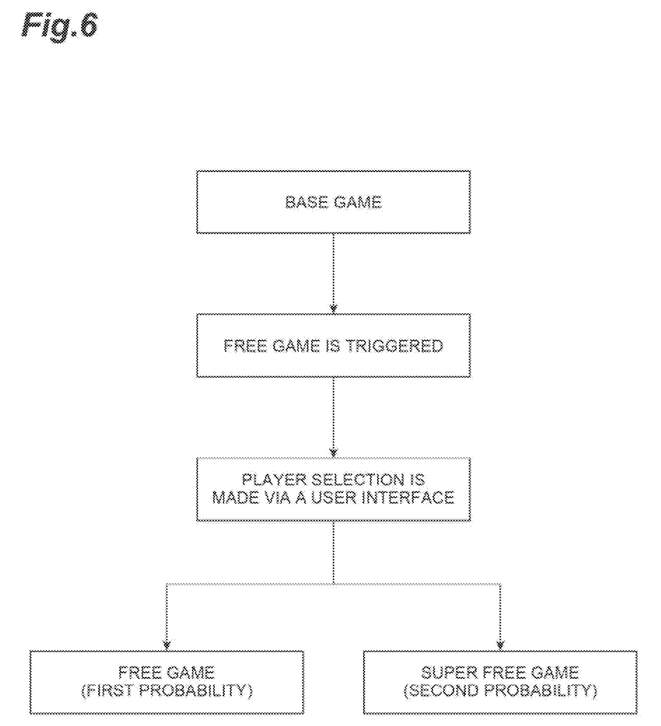

FIG. 6 is a diagram illustrating a relationship between a base game and a free game. As shown in FIG. 6, when a free game is triggered during a base game, a player selection is made via a user interface. The control unit 22 may display the probability with which the game feature is provided and the number of times the game is provided for the free game (an example of a first free game) and the super free game (an example of a second free game) on the display 16 in a comparable form, to encourage the player to select either the free game or the super free game.

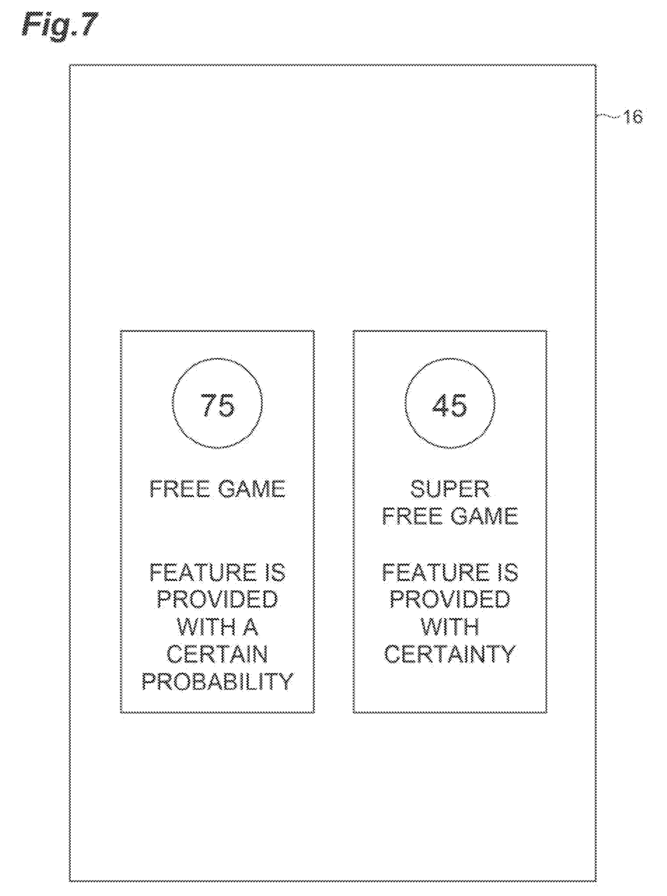

FIG. 7 is a diagram illustrating an example of a screen for receiving a player's selection. As shown in FIG. 7, the display 16 displays that the free game is provided "75" times and the game feature is provided with a certain probability, and that the super free game is provided "45" times and the game feature is provided with certainty. The number of times the super free game is provided (an example of a second number of times) is set to be smaller than the number of times the free game is provided (an example of a first number of times). The player can select either the free game or the super free game. By presenting the number of times provided and the activation condition of the game feature, the player can be made to consider the balance between the magnitude of the winning opportunity and the return. Therefore, it can encourage the player to think more strategically when selecting a free game.

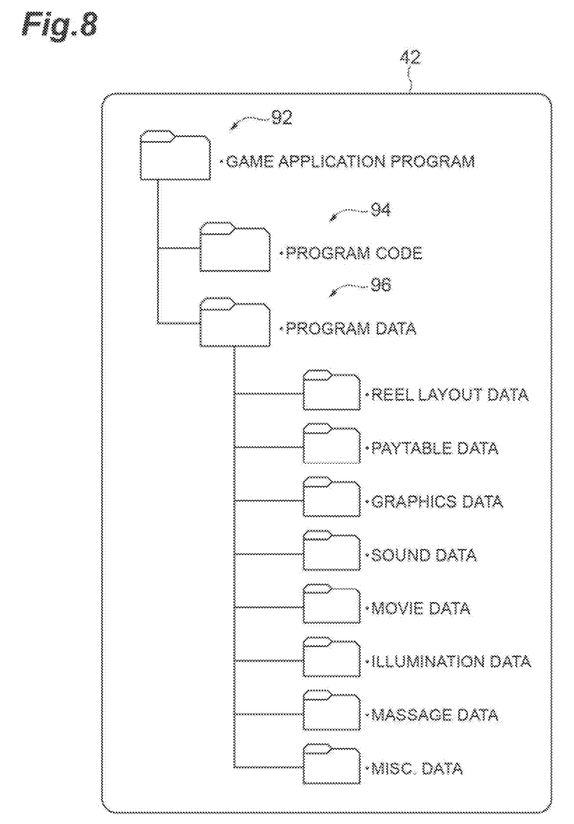

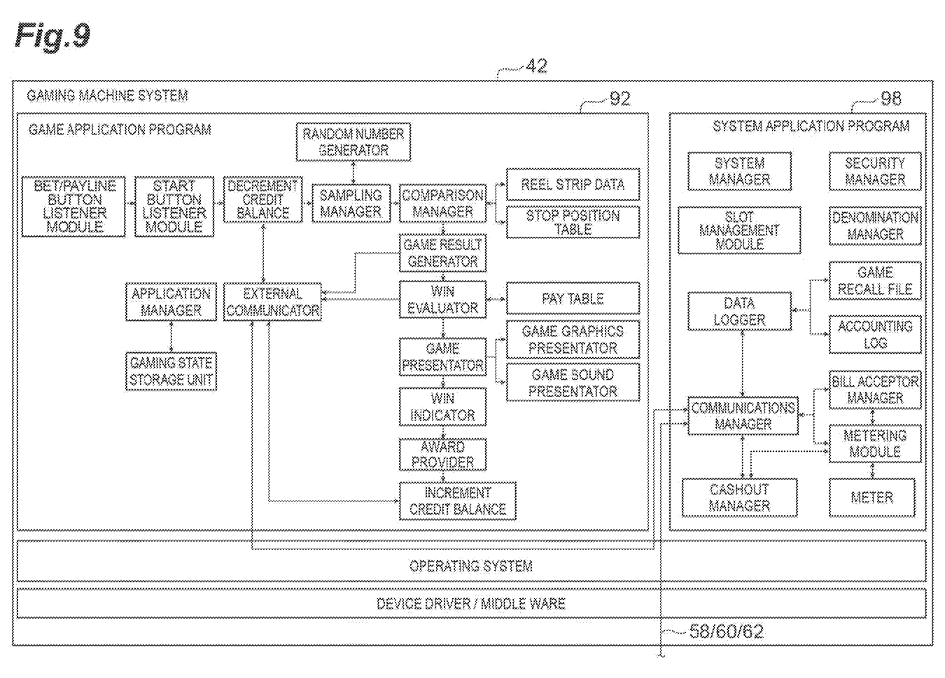

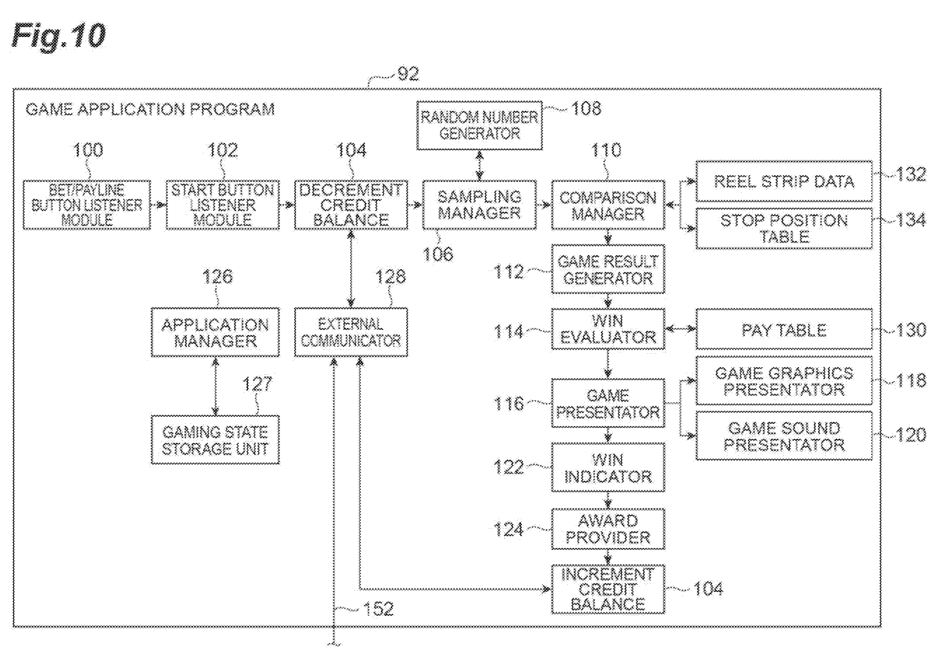

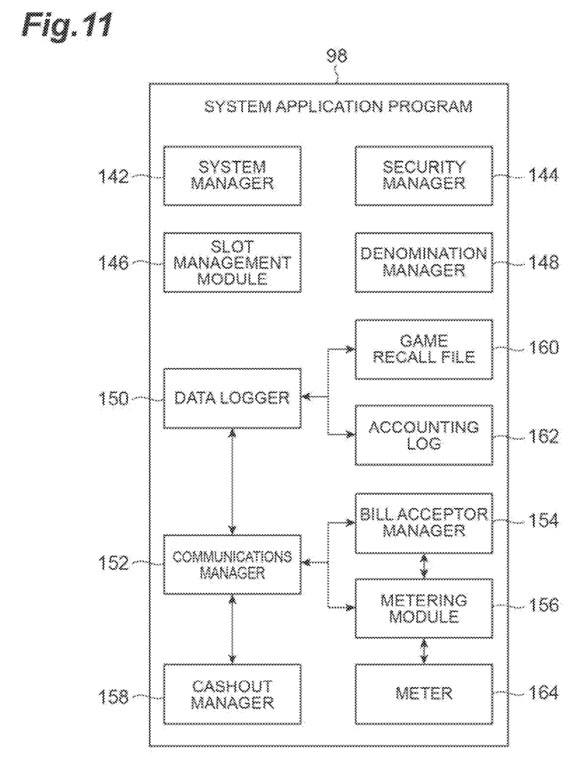

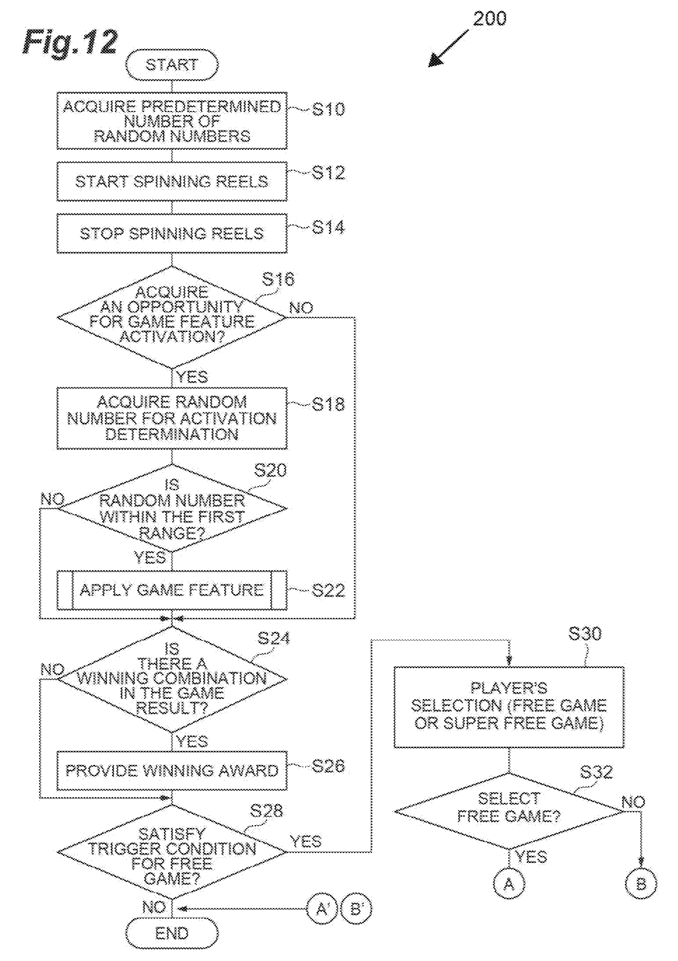

FIGS. 8 and 9 are a directory configuration diagram and a block diagram showing programs and data stored in the memory of FIG. 2. FIG. 10 is a block diagram of the game application program of FIG. 9. FIG. 11 is a block diagram of the system application program shown in FIG. 9. In the embodiments shown in FIGS. 8 to 11, the memory 42 stores a game application program 92 including computer-executable instructions, and processing of the game is performed by executing these computer-executable instructions in CPU 38, and the game screen is displayed on the display 16 in the gaming machine 10. Also, in one embodiment, the game application program 92 includes program code 94 and program object data 96 that include computer-executable instructions for implementing a game using the algorithms shown in FIGS. 12 to 14.

In an exemplary embodiment, the memory 42 stores the game application program 92 and a system application program 98 including computer-executable instructions that are executed in the CPU 38 to process the game and display a game screen on the display 16 of the gaming machine 10. The game application program 92 provides a game-specific front-end function by executing on the CPU, and the system application program 98 provides a generic back-end function. In the illustrated embodiment, the game application program 92 and the system application program 98 are implemented on the same operating system. However, it should be noted that these programs may be implemented on respective operating systems and/or by respective processors.

In one embodiment, the game application program 92 includes a plurality of software modules including a bet/payline button listener module 100, a start button listener module 102, a credit balance manager module 104, a sampling manager 106, a random number generator (RNG) 108, a comparison manager 110, a game result generator 112, a win evaluator 114, a game presentator 116, a game graphics presentator 118, a game sound presenter 120, a win indicator 122, an award provider 124, an application manager 126, and an external communicator 128. The game application program 92 may also include a pay table 130, reel strip data 132, and a stop position table 134.

The bet/payline button listener module 100 is a software module for receiving a signal from a bet button of the operation unit 32, the signal being generated by the button when the player operates the button to select a bet amount. In response to receiving the signal, the bet/payline button listener module 100 communicates the occurrence of the signal to the application manager 126 for changing the bet of the game.

The start button listener module 102 is a software module for receiving a signal from a start button, which is generated when the player operates the button to start a game. In response to receiving the signal, the start button listener module 102 communicates the occurrence of the signal to the application manager 126 to initiate the game.

In response to receiving a signal from the start button listener module 102, the application manager 126 requests the sampling manager 106 to obtain the required number of random numbers from the random number generator 108.

The random number generator 108 is a software module for generating random numbers based on a predetermined algorithm of computational random generation method. The random number generator 108 may be a pseudorandom number generator. The random number generator 108 returns the random numbers in response to a request from the sampling manager 106. The random number generator 108 may be implemented in part or in whole as an integrated circuit or wired logic.

The comparison manager 110 compares the current state of the game and/or each random number with the reel strip data 132 and the stop position table 134, and specifies the stopping position of the corresponding reel strip based on each random number.

The reel strip data 132 has virtual reel strips for base games, free games, and special games. The comparison manager 110 described above queries the application manager 126 to identify the current state of the game and selects virtual reel strips.

The stop position table 134 includes a range of random numbers associated with each stopping position of the virtual reel strip. The comparison manager 110 determines the stopping position of each reel based on the corresponding random number and the stop position table 134.

The game result generator 112 generates a game result based on the selected reel layout, the stopping position of each reel, the stopping position of the inner symbol, and the attribute to be added. In one embodiment, the game result generator 112 may apply a change on the game result when a predetermined condition is satisfied.

The win evaluator 114 evaluates the game result with reference to the pay table 130. To be specific, the winning evaluation is performed based on whether symbols defined as a winning combination in the pay table 130 stop.

The game presentator 116 utilizes the game graphics presentator 118 and the game sound presentator 120 to provide a game presentation process consisting of video animation and sound to eventually form a predetermined game result.

The game sound presentator 120 provides a sound presentation process by using the sound controller 53 and speakers 26. The win indicator 122 indicates a winning combination and a payment condition of prize symbol formed in the game result. The award provider 124 provides award credit to the win meter based on the win evaluation.

The application manager 126 administrates the operation and state of each software module. In addition, the application manager 126 administrates the configuration, progress, and states of the game application program 92. The application manager 126 refers to a gaming state storage unit 127, determines the size of the symbol display region 64 based on the stored game state, and provides the game. The external communicator 128 communicates instructions and data with the system application program 98.

The credit balance manager module 104 executes a process for decrementing the credit balance according to the bet amount and incrementing the credit balance based on the total amount of winnings displayed on the winning meter. The pay table 130 includes a payout amount or award amount associated with each winning combination.

In an exemplary embodiment, the system application program 98 provides background processing and functions other than game-specific functions. The system application program 98 includes a plurality of software modules including a system manager 142, a security manager 144, a slot management module 146, a denomination manager 148, a data logger 150, a communications manager 152, a bill acceptor manager 154, a metering module 156, and a cashout manager 158.

The system application program 98 may include a game recall file 160, an accounting log 162, and a meter 164. The system manager 142 is a software module for administrating all of the background processing and functions other than game-specific functions conducted by the system application program 98.

The security manager 144 is a software module for administrating game verification, door security, and monitoring security sensors. The slot management module 146 is a software module for administrating data accumulation and communicating with an external slot information system.

The denomination manager 148 is a software module for establishing the denomination setting of the gaming machine 10. The denomination setting may include 1 cent, 2 cents, 5 cents, 25 cents, 1 dollar, 5 dollars and the like. The data logger 150 is a software module for logging the results of each game in a game recall. In addition, the data logger 150 stores error events, bill logs, cashout logs, ticket logs, and the like in an accounting log.

The game recall file 160 is an accumulated data including the results of each game. The game recall file 160 is stored in non-volatile memory. The accounting log 162 is an accumulated data including error events, bill logs, cashout logs, ticket logs and the like. The accounting log 162 is stored in non-volatile memory.

The communications manager 152 is a software module for administrating communication between the game application program 92 and the system application program 98. The communications manager 152 also administrates network communications between the system application program 98 and other gaming machines 10, external network such as slot management system network, G2S network, gaming server for server-based gaming network or VLT system network.

The bill acceptor manager 154 is a software module for managing bill acceptors, and accepts bill information inserted in the bill acceptor. In response to receiving the information from the bill acceptor, the bill acceptor manager 154 communicates with the metering module to increment the credit balance based on the inserted bill.

The metering module 156 is a software module for adjusting the value of the meter 164 in response to communication with the game application program 92 via the communications manager 152, the bill acceptor manager 154 or the cashout manager 158. The meter 164 includes a credit meter to indicate the current credit balance of the gaming machine and a win meter to indicate the total amount of wins for the current gaming session. The meter further includes background meters, such as coin-in, coin-out, total drop, attendant paid jackpot and/or bill-in. These meters may be implemented as a data on non-volatile memory or hardware meters.

The cashout manager 158 is a software module for administrating a cashout procedure. In response to the player's operation on the cashout button, the cashout manager 158 is activated and the gaming machine pays the total amount of credit meters in cash or a voucher.

FIGS. 12 to 14 are flowcharts illustrating an algorithm 200 executed by the CPU for operating the gaming machine to display a computer-animated animated reel game 202. The algorithm 200 (gaming method) of the operation of the gaming machine is implemented in the game application program 92 and is embodied by the CPU 38 executing the game application program 92. The algorithm 200 for the operation of the gaming machine includes a plurality of steps. Each step may be performed independently or may be performed in combination with other steps.

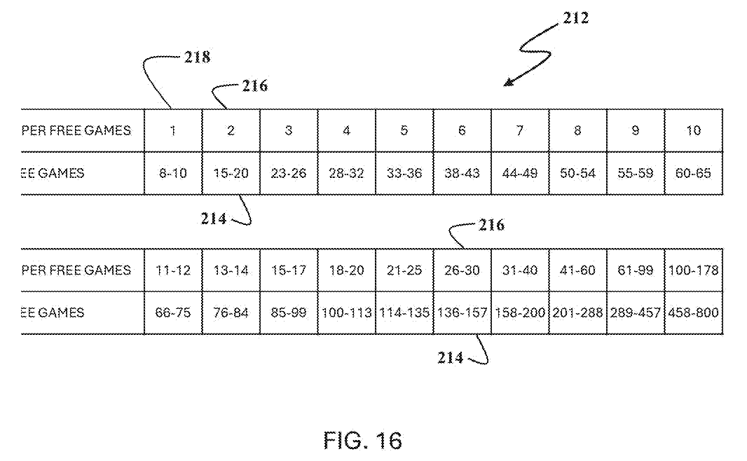

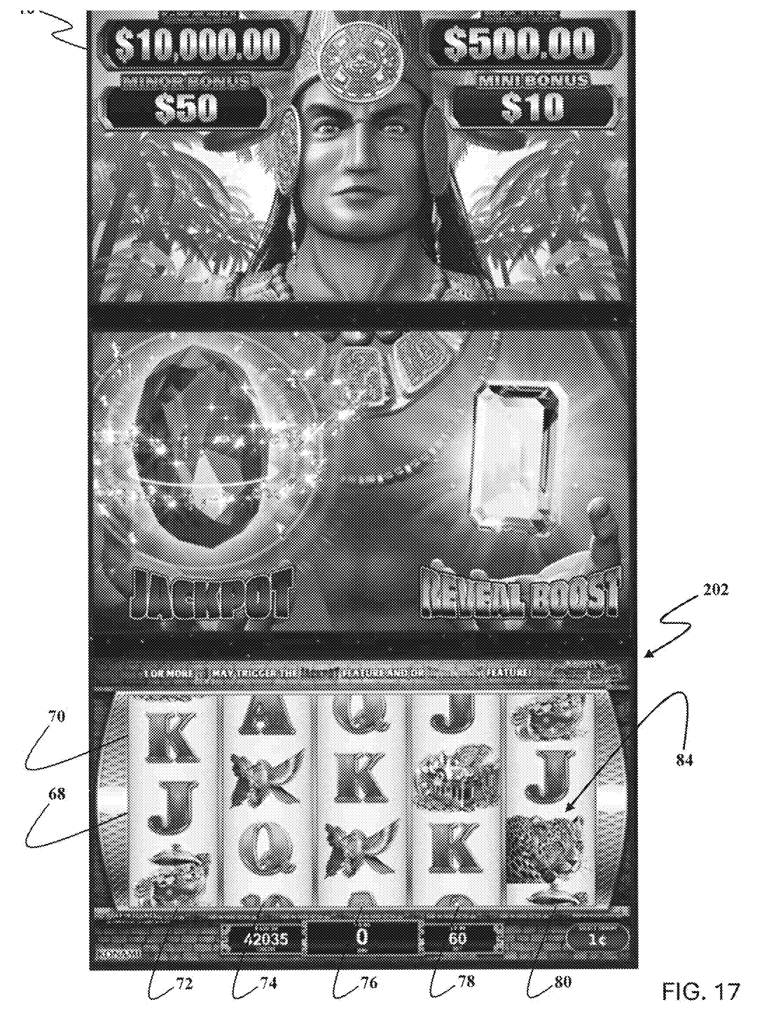

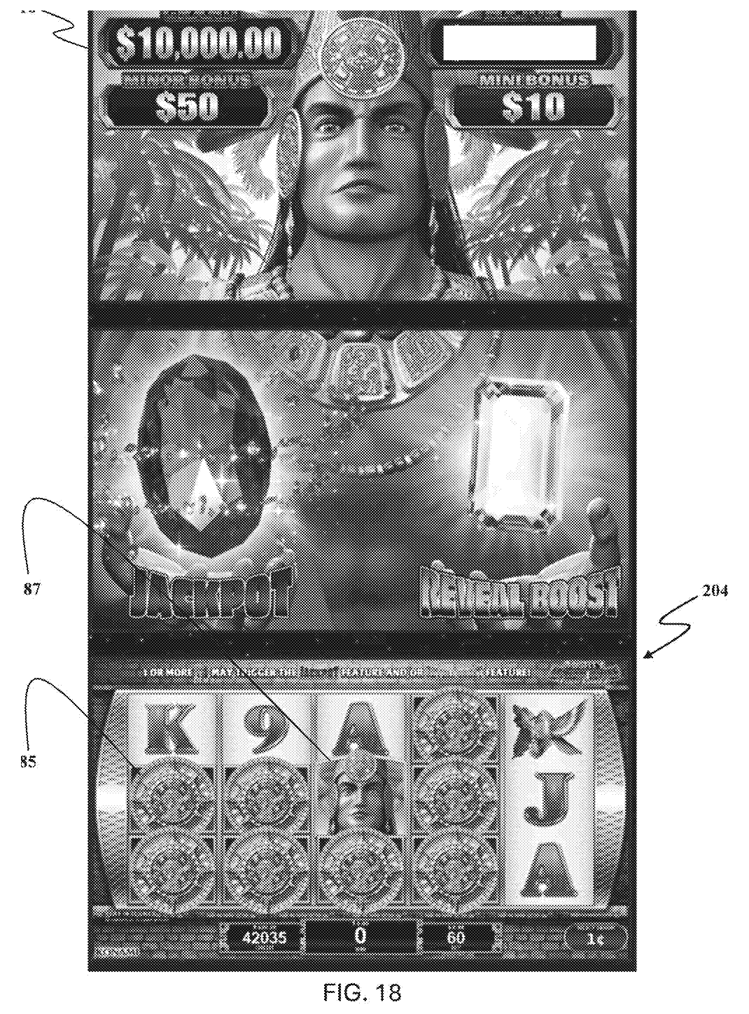

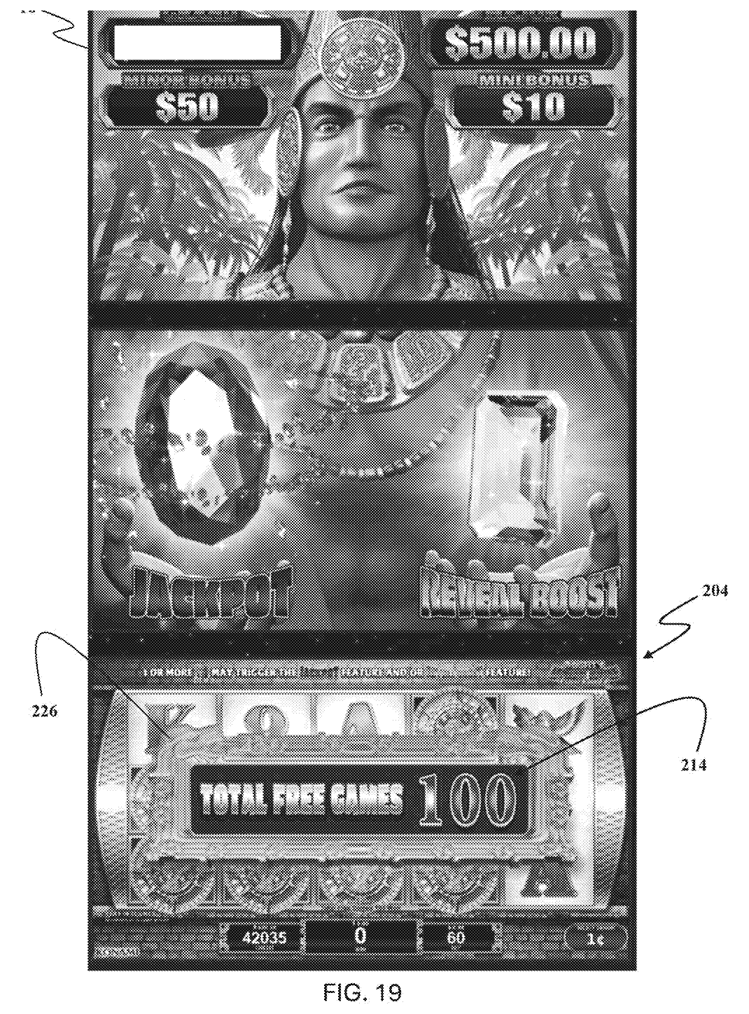

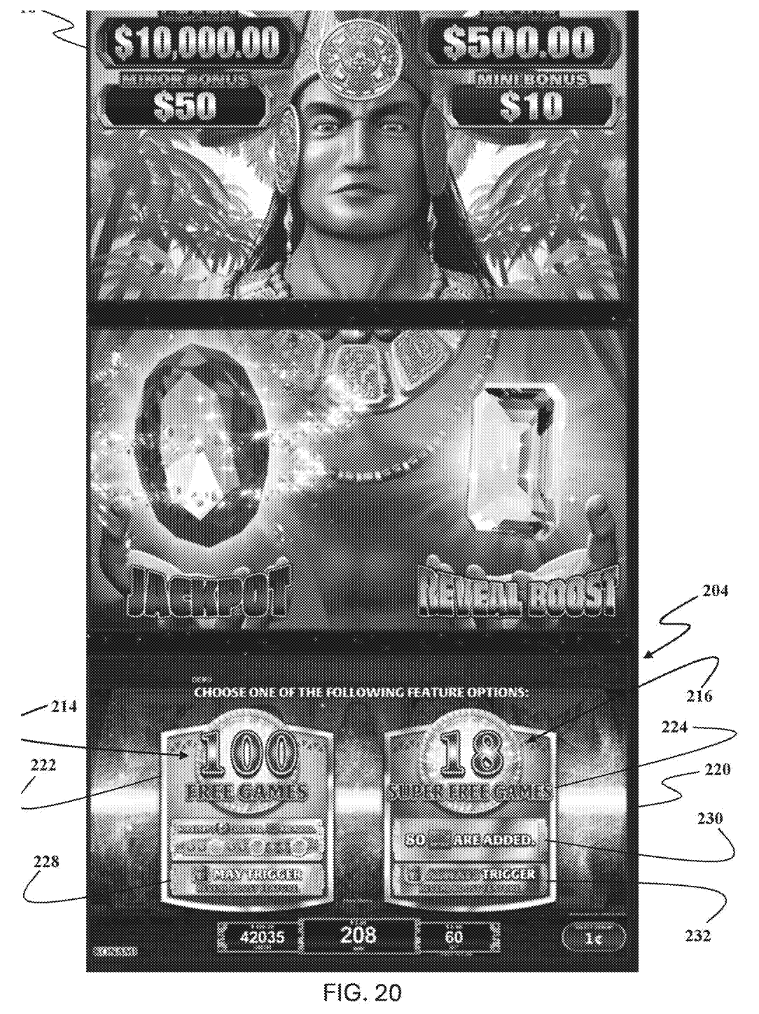

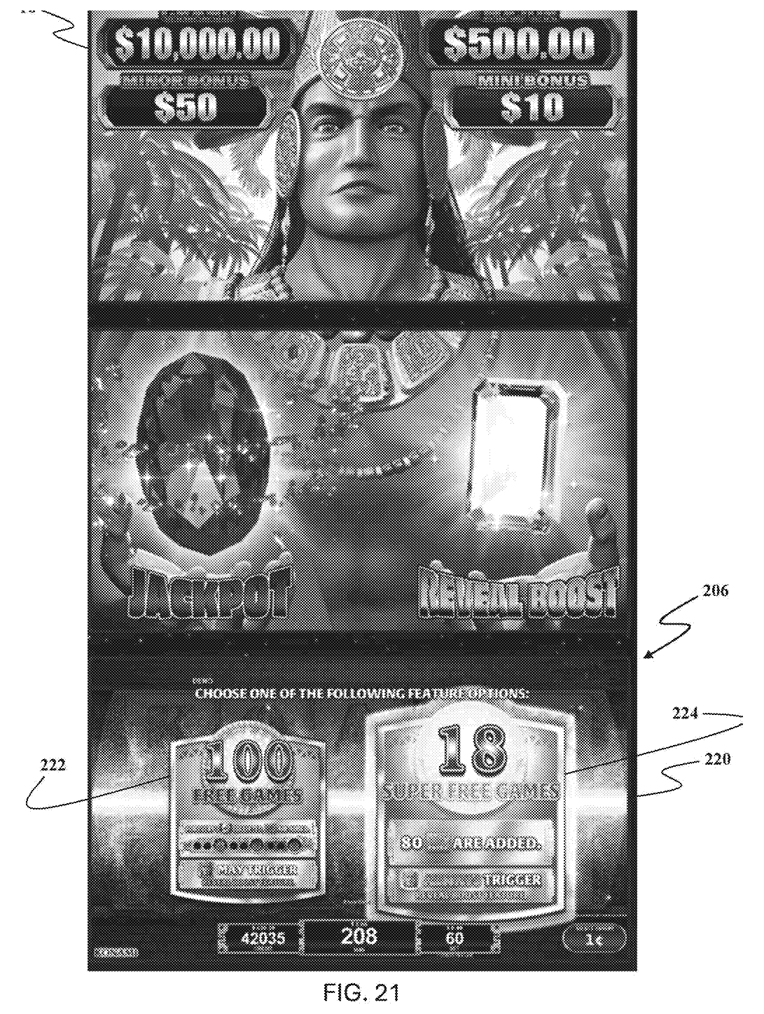

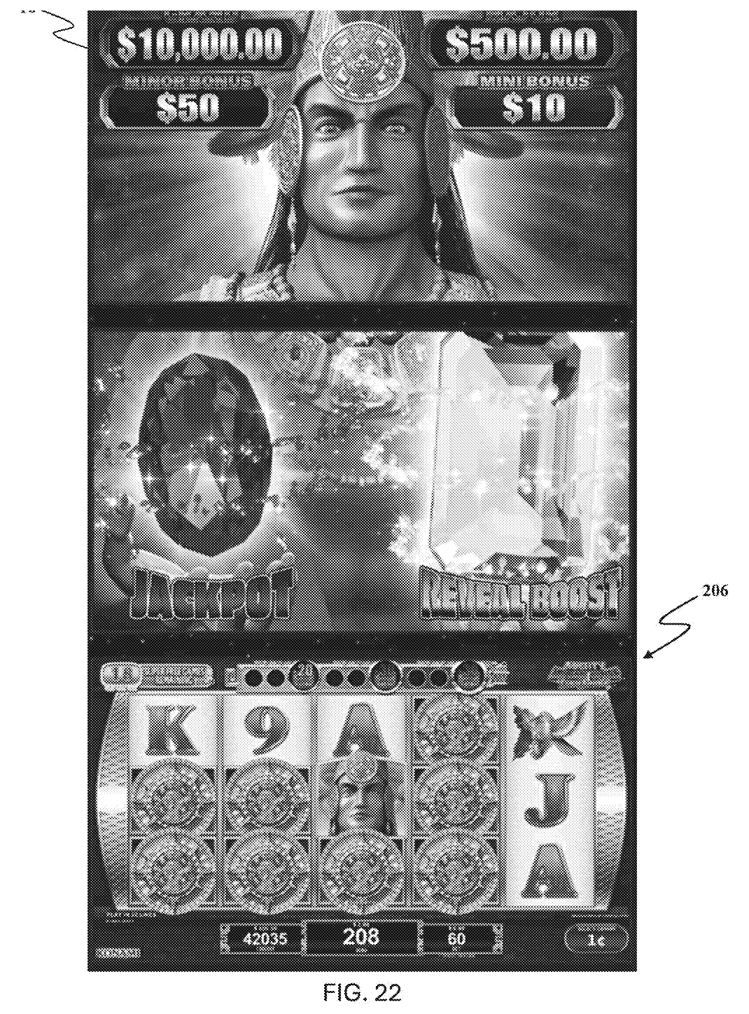

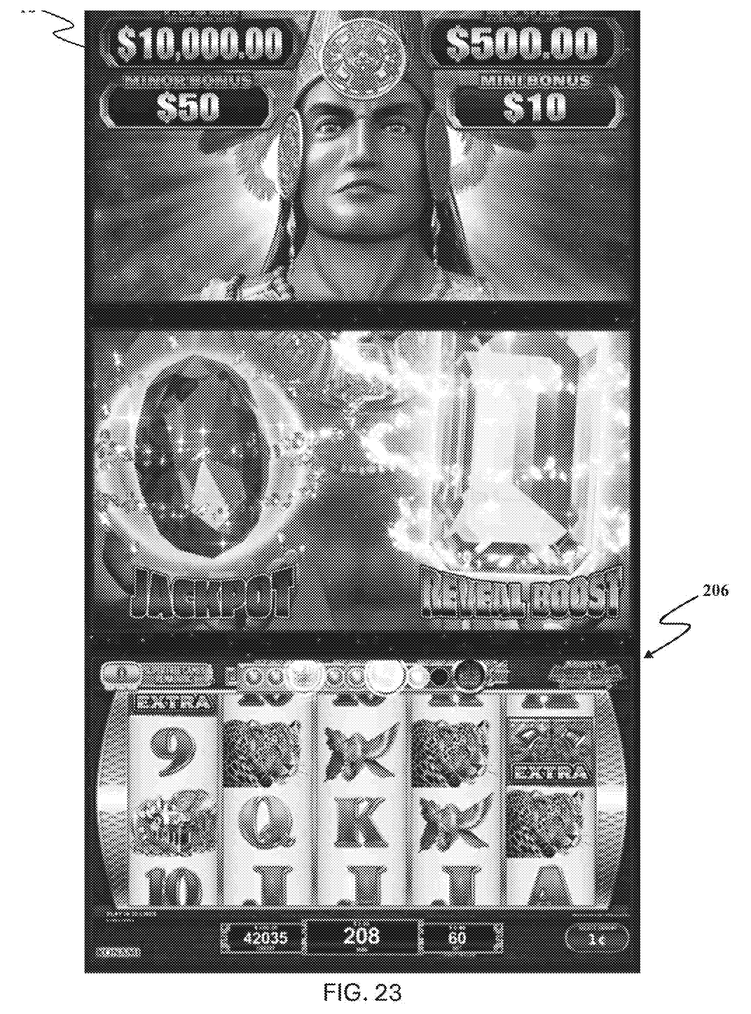

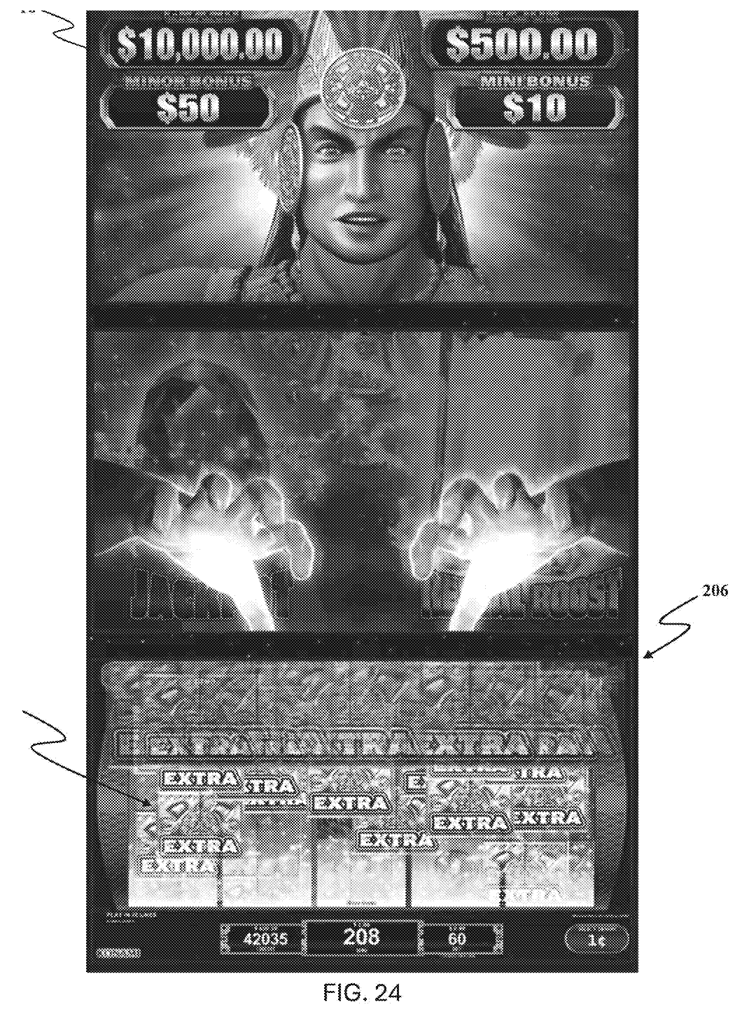

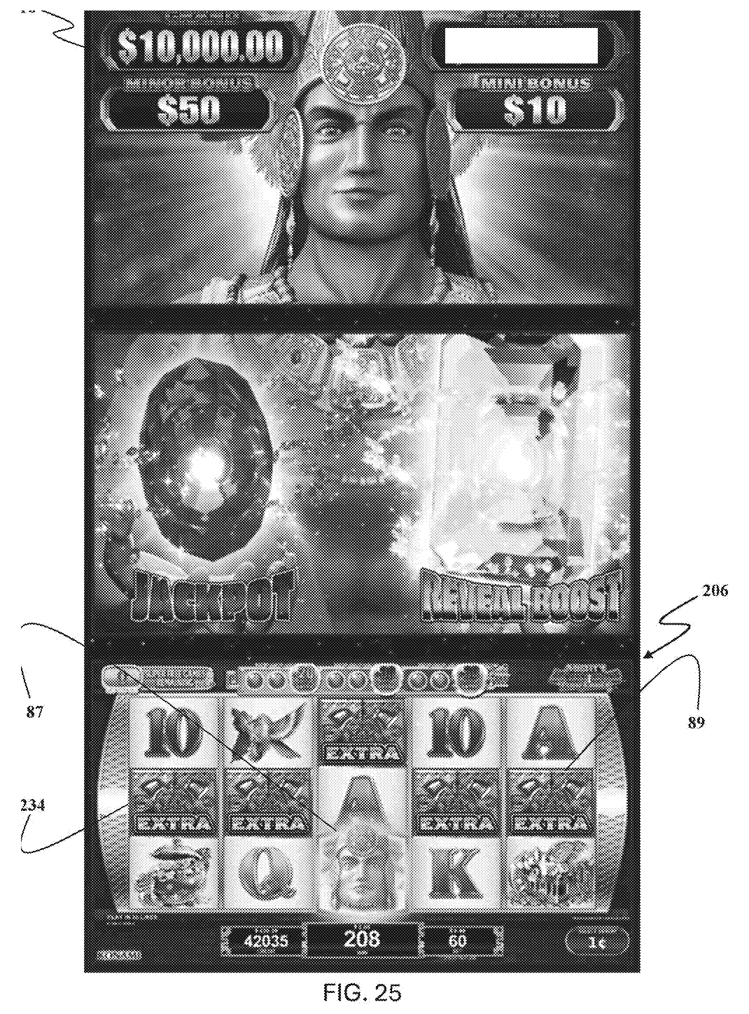

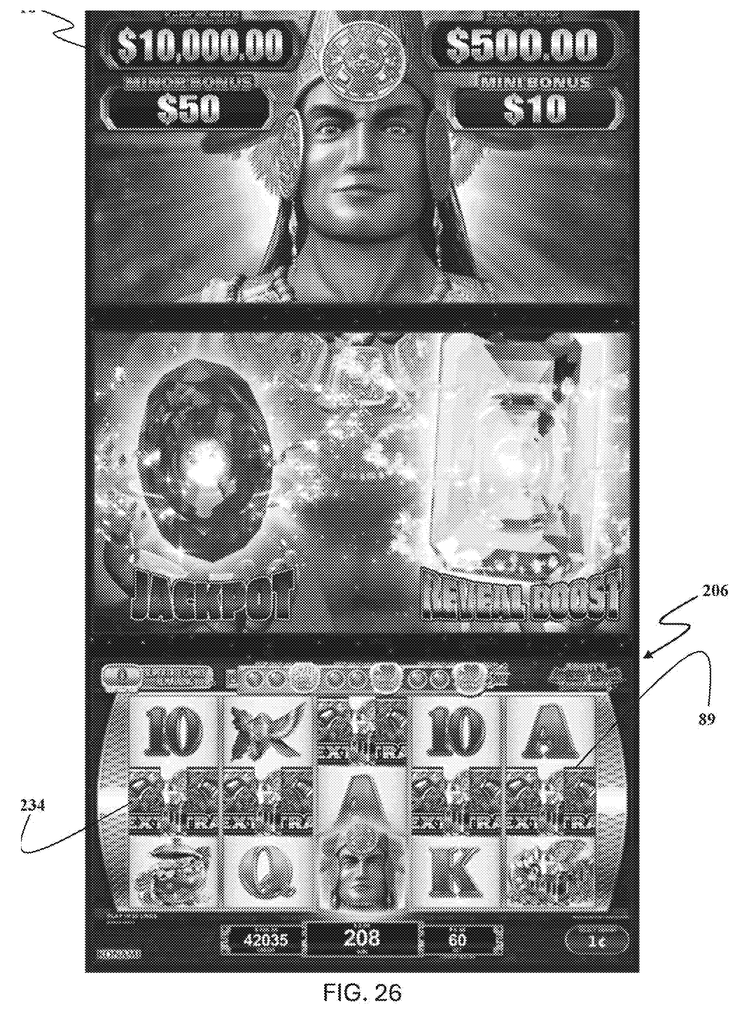

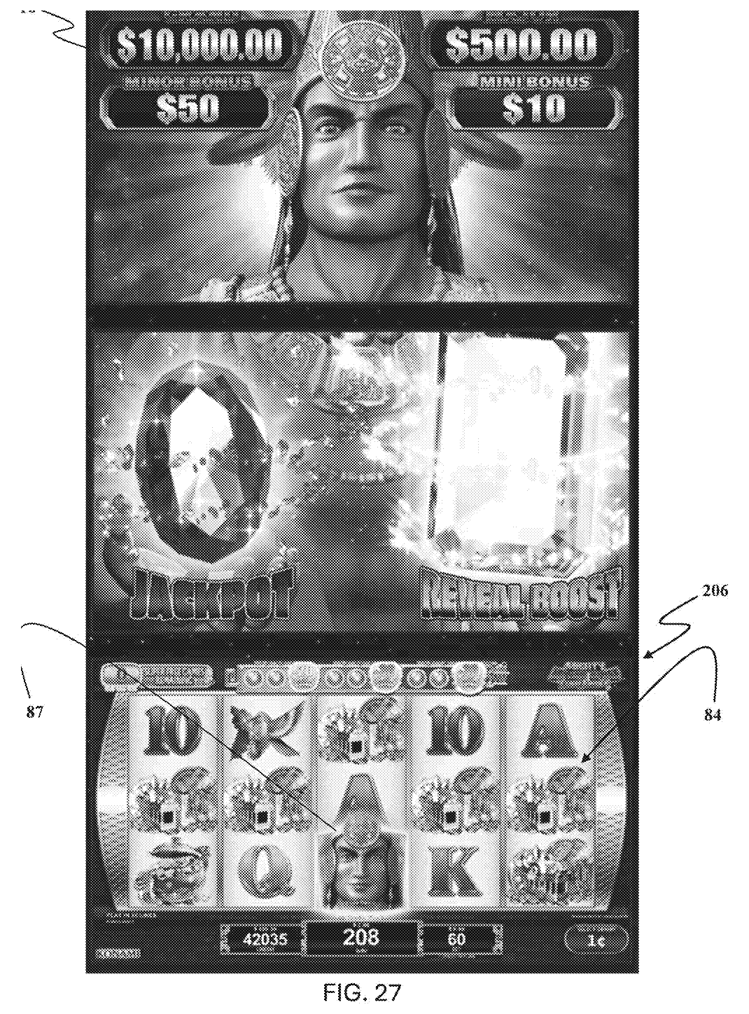

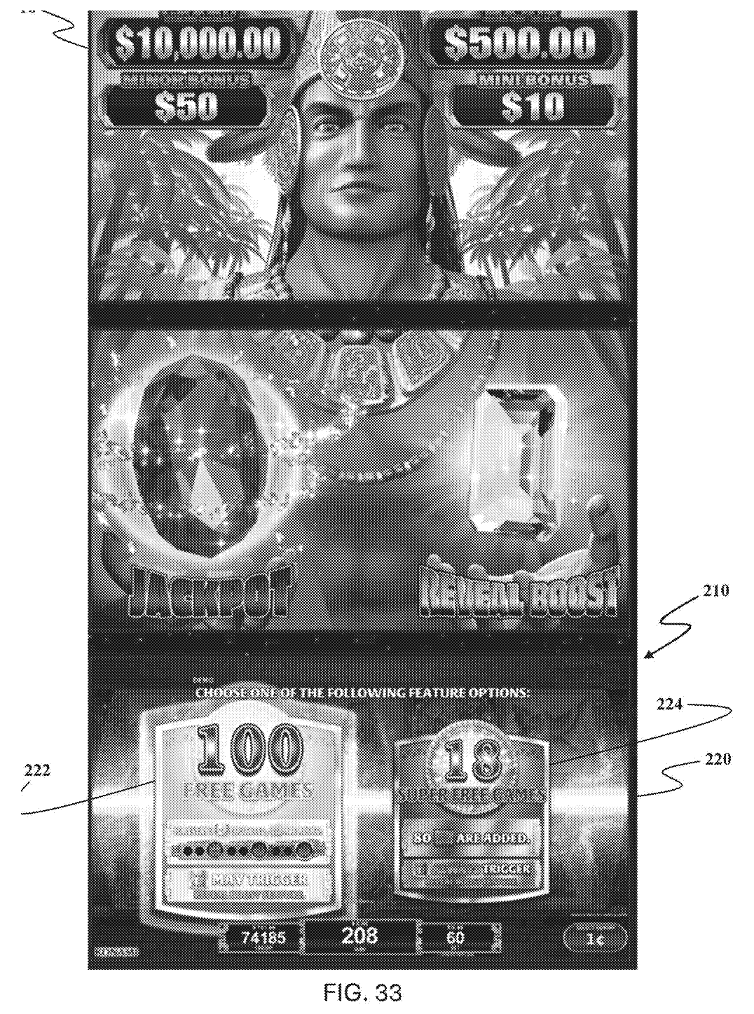

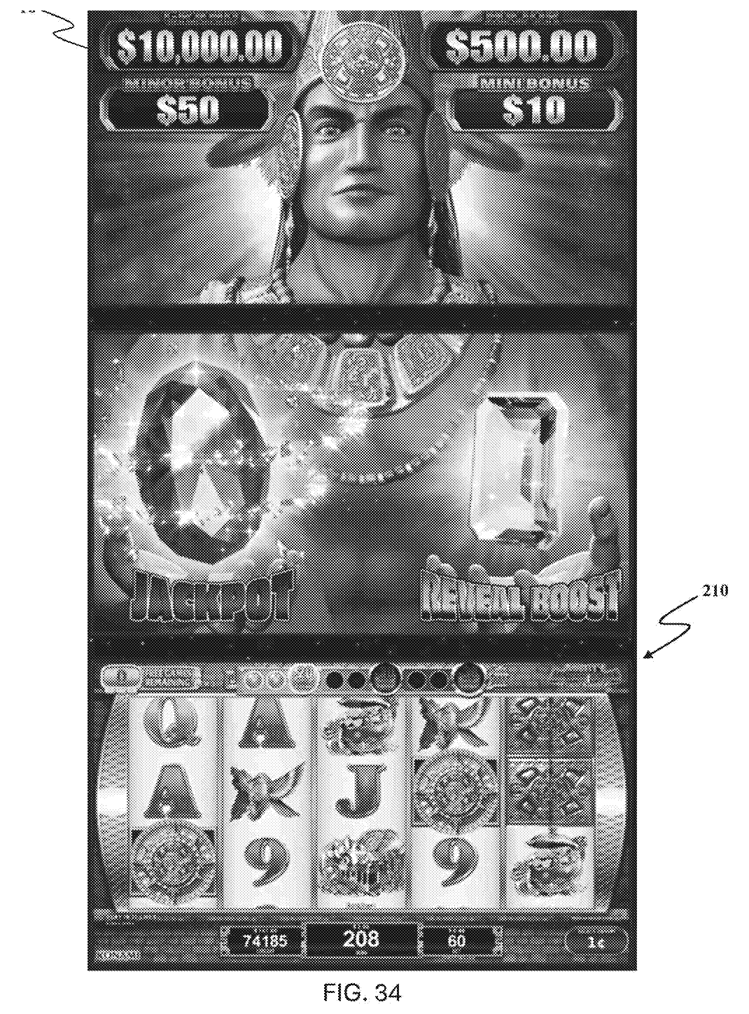

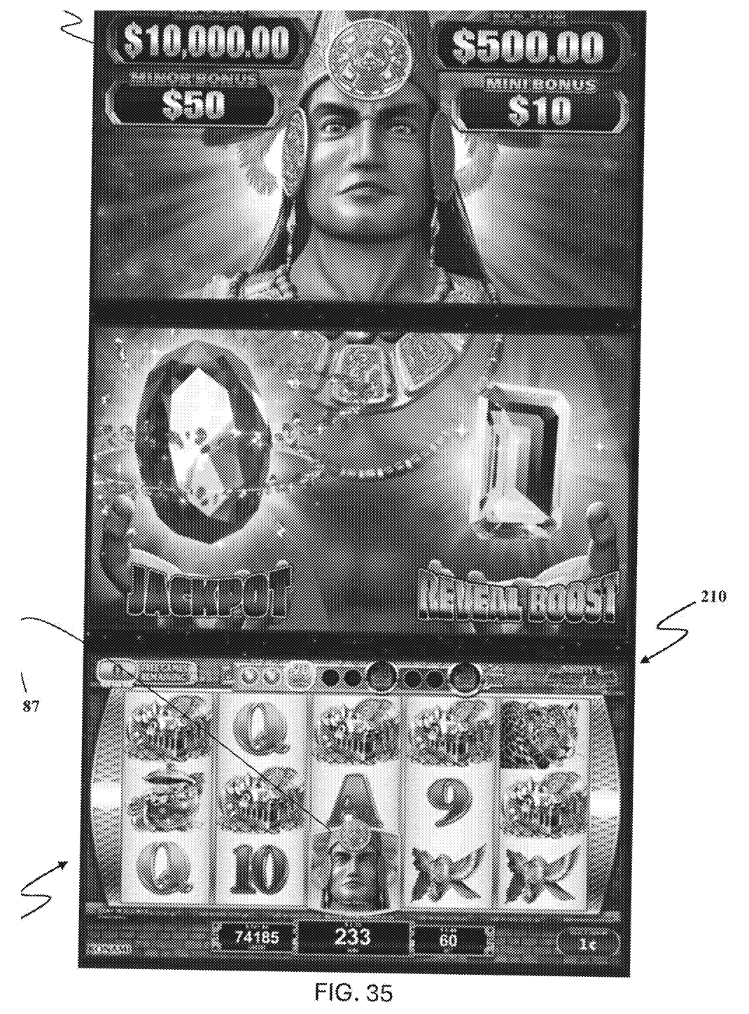

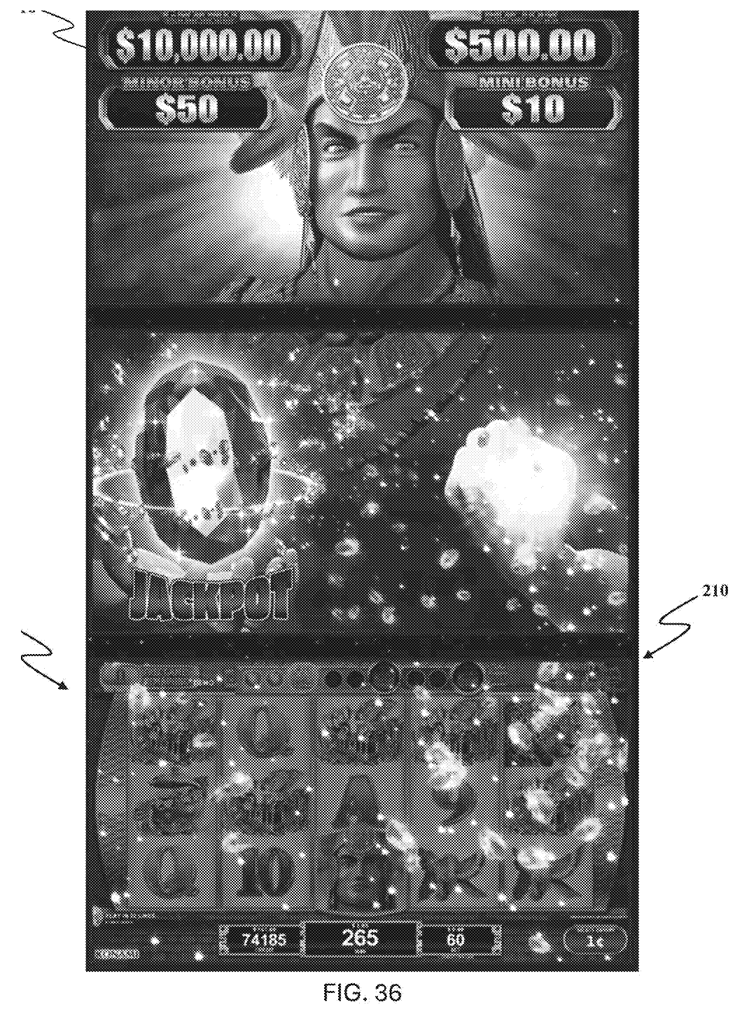

FIGS. 17-41 are exemplary game screens of the computer-animated reel game 202 illustrating the animation sequences displayed when executing algorithm 200. For example, FIGS. 17-20 are exemplary game screens of a free game selection animation sequence 204 displayed when executing the algorithm 200, FIGS. 21-32 are exemplary game screens of a super free game animation sequence 206 displayed when executing the algorithm 200 with FIGS. 28-32 illustrating a reveal boost game feature animation sequence 208, and FIGS. 33-41 are exemplary game screens of a free game animation sequence 210 displayed when executing the algorithm 200 with FIGS. 36-41 illustrating the reveal boost game feature animation sequence 208. FIG. 16 is an illustration of exemplary super free game data lookup table 212 that may be used when executing the algorithm 200.

As shown in FIG. 12, in step S10, the control unit 22 receives a game start operation by the player, and upon receiving an operation of the spin button from the player, subtracts the set total bet amount from the credit and acquires a predetermined number of random numbers required to provide the game. The random numbers are generated internally in the random number generator 108 of the control unit 22. The control unit 22 may acquire the random numbers from a random number generator provided separately from the control unit 22, or may acquire the random numbers from devices such as servers provided outside the gaming machine 10.

The control unit 22 starts spinning a plurality of reels in step S12. Next, the control unit 22 stops spinning the plurality of reels in step S14. In step S16, the control unit 22 determines whether an opportunity for the game feature to be activated has been acquired. For example, if the game feature is configured to be activated with a certain probability when a predetermined symbol is included in the game result, the control unit 22 determines that an opportunity for the game feature to be activated has been acquired when a predetermined symbol is included in the game result.

If it is determined that an opportunity for the game feature to be activated has been acquired (step S16: YES), the control unit 22 acquires a random number for determining the activation of the game feature in step S18. The random number is acquired by any of the methods described in step S10. Subsequently, in step S20, the control unit 22 determines whether the random number acquired in step S18 is within a first range. If it is determined that the random number is within the first range (step S20: YES), the control unit 22 applies the game feature in step S22. For example, the control unit 22 replaces some symbols in the symbol combination with inner symbols 89 in the symbol combination displayed as the game result. Then, the control unit 22 converts the inner symbol 89 into one of the symbols included in the pay table.

If it is determined that an opportunity for the game feature to be activated has not been acquired (step S16: NO), if it is determined that the random number is not within the first range (step S20: NO), or when step S22 is completed, the control unit 22 determines the symbol combination as the game result and determines whether the symbol combination has a winning combination in step S24. If it is determined that there is a win (step S24: YES), the control unit 22 provides an amount corresponding to the win as an award in step S26. For example, the control unit 22 adds the amount corresponding to the win to the held credit. The control unit 22 may also provide the award if a win is formed before being replaced with the inner symbol 89. If it is determined that there is no win (step S24: NO), no award is provided.

Subsequently, in step S28, the control unit 22 determines whether a trigger condition for a free game is satisfied. For example, the control unit 22 determines that the trigger condition for a free game is satisfied if a predetermined number of trigger symbols 85 are included in the game result.

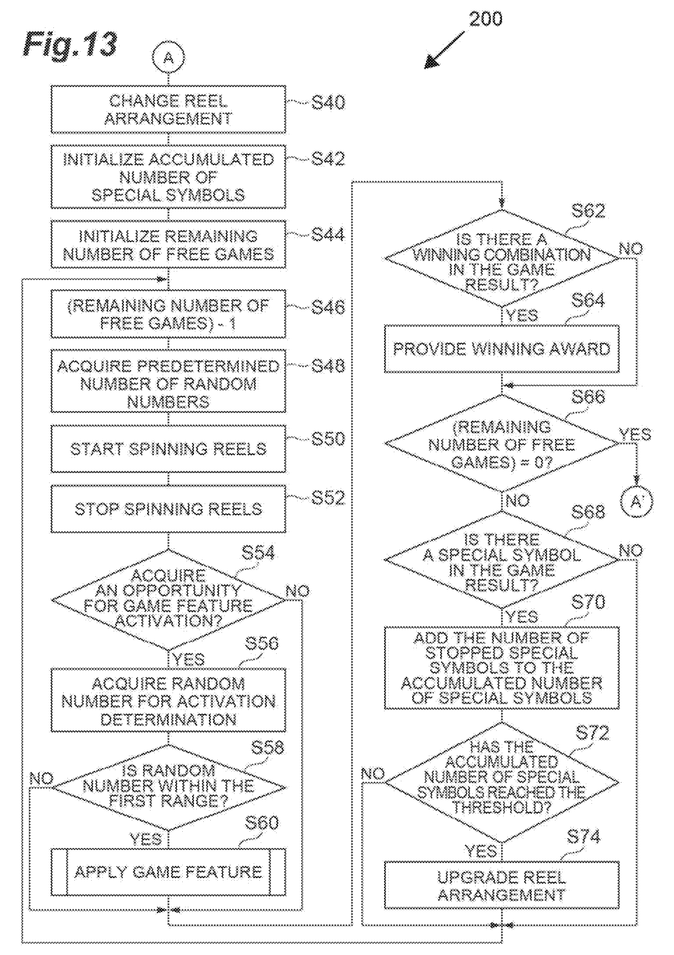

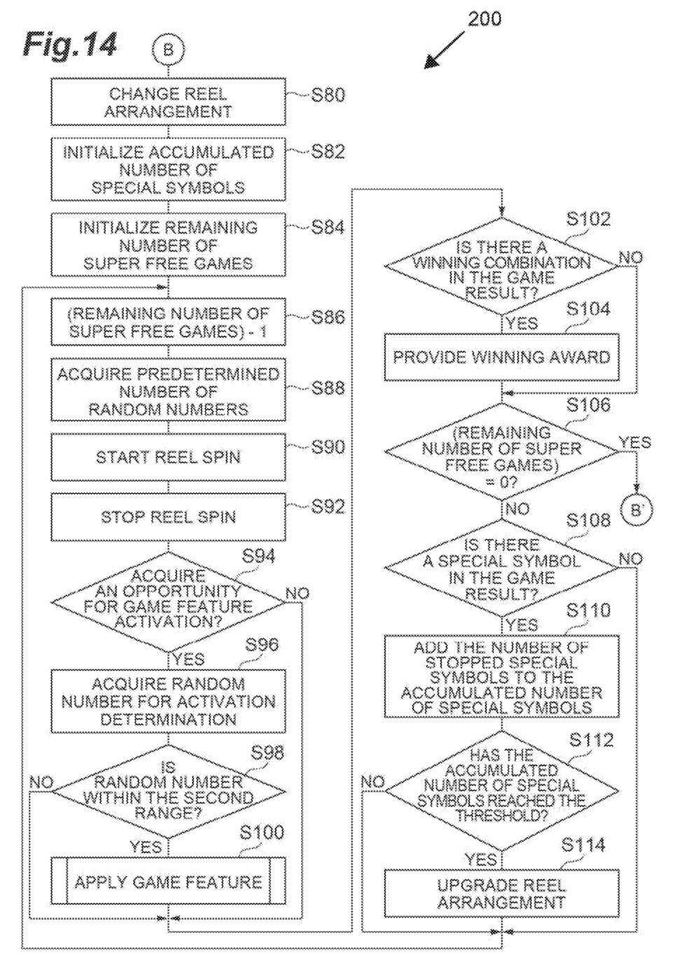

If it is determined that the trigger condition for a free game is satisfied (step S28: YES), the control unit 22 receives a player's selection in step S30. For example, the control unit 22 displays a screen for receiving a player's selection as shown in FIG. 7 and receives the player's selection. Subsequently, if a free game is selected (step S32: YES), the control unit 22 proceeds to the flowchart shown in FIG. 13 (A in the figure), and if a super free game is selected (step S32: NO), the control unit 22 proceeds to the flowchart shown in FIG. 14 (B in the figure). FIGS. 13 and 14 are flowcharts for explaining the operation of the gaming machine.

First, the case where a free game is selected will be described. As shown in FIG. 13, first, in step S40, the control unit 22 changes the reel arrangement. For example, the control unit 22 enhances the virtual reel strip more than that in the base game. Subsequently, in step S42, the control unit 22 initializes the accumulated number of special symbols. For example, the accumulated number of special symbols is set to 0. Subsequently, in step S44, the control unit 22 initializes the remaining number of free games. For example, the control unit 22 sets the number of times the free game is provided, which was presented to the player in step S30, as the remaining number of free games. Subsequently, in step S46, the control unit 22 decrements the remaining number of free games by one.

Then, the control unit 22 acquires a random number in step S48. The random number is acquired by any of the methods described in step S10. The control unit 22 starts spinning a plurality of reels in step S50. Next, the control unit 22 stops spinning the plurality of reels in step S52. In step S54, the control unit 22 determines whether an opportunity for the game feature to be activated has been acquired. This game feature is the same or corresponding game feature as the base game and the super free game described later. For example, when the game feature is activated with a certain probability when a predetermined symbol is included in the game result, the control unit 22 determines that an opportunity for the game feature to be activated has been acquired when a predetermined symbol is included in the game result.

If it is determined that an opportunity for the game feature to be activated has been acquired (step S54: YES), the control unit 22 acquires a random number for determining the activation of the game feature in step S56. The random number is acquired by any of the methods described in step S10. Subsequently, in step S58, the control unit 22 determines whether the random number acquired in step S56 is within a first range. If it is determined that the random number is within the first range (step S58: YES), the control unit 22 applies the game feature in step S60. For example, the control unit 22 replaces some symbols in the symbol combination with inner symbols 89 in the symbol combination displayed as the game result. At this time, the control unit 22 may replace a larger number of inner symbols 89 than in the base game. Then, the control unit 22 converts the inner symbol 89 into one of the symbols included in the pay table.

If it is determined that an opportunity for the game feature to be activated has not been acquired (step S54: NO), if it is determined that the random number is not within the first range (step S58: NO), or when step S60 is completed, the control unit 22 determines the symbol combination as the game result and determines whether the symbol combination has a winning combination in step S62. If it is determined that there is a win (step S62: YES), the control unit 22 provides an amount corresponding to the win as an award in step S64. For example, the control unit 22 adds the amount corresponding to the win to the held credit. The control unit 22 may also provide the award if a win is formed before being replaced with the inner symbol 89. If it is determined that there is no win (step S62: NO), no award is provided.

Subsequently, in step S66, the control unit 22 determines whether the remaining number of free games is 0. If it is determined that the remaining number of free games is not 0 (step S66: NO), the control unit 22 determines whether the game result includes a special symbol 87 in step S68. If it is determined that the game result includes a special symbol 87 (step S68: YES), the control unit 22 adds the number of stopped special symbols 87 to the accumulated number of special symbols in step S70. Subsequently, in step S72, the control unit 22 determines whether the accumulated number of special symbols has reached a threshold. If it is determined that the accumulated number of special symbols has reached the threshold (step S72: YES), the control unit 22 upgrades the reel arrangement. For example, the control unit 22 removes card symbols from the virtual reel strip or adds inner symbols 89 to the virtual reel strip. Note that a plurality of thresholds may be prepared, and the degree of enhancement may be set for each threshold.

If it is determined that the game result does not include a special symbol 87 (step S68: NO), if it is determined that the accumulated number of special symbols has not reached the threshold (step S72: NO), or when step S72 is completed, the control unit 22 returns to step S46. In this way, the processing from step S46 to step S74 is repeatedly executed until it is determined that the remaining number of free games is 0 (step S66: YES). If it is determined that the remaining number of free games is 0 (step S66: YES), the flowchart shown in FIG. 13 ends, and the process returns to the flowchart shown in FIG. 12 (A' in the figure).

Next, the case where a super free game is selected will be described. Regarding the operation of the super free game shown in FIG. 14 (steps S80 to S114), compared to the operation of the free game shown in FIG. 13 (steps S40 to S74), the range used for determining the activation of the game feature is a second range that is larger than the first range, and the degree of enhancement of the reel arrangement is different, but the rest is the same. Since the range is a second range that is larger than the first range, the super free game has a higher probability of the game feature being provided than the free game. When the flowchart shown in FIG. 14 ends, the process returns to the flowchart shown in FIG. 12 (B' in the figure).

Returning to FIG. 12, if it is determined that the trigger condition for a free game is not satisfied (step S28: NO), when the free game shown in FIG. 13 ends (A' in the figure), or when the super free game shown in FIG. 14 ends (B' in the figure), the flowchart shown in FIG. 12 ends.

As described above, in the gaming machine 10, the game feature is provided with a first probability in the free game (an example of a first free game), and the game feature is provided with a second probability higher than the first probability in the super free game (an example of a second free game). The gaming machine 10 can provide the game feature with different probabilities for each free game. Therefore, the player can be made aware of the probability with which the game feature is provided, and can be made to play the game with an expectation that the feature will be triggered. At the same time, the player can have a different playing experience for each free game, and the results of the game can be further diversified. Thus, the gaming machine 10 can provide a game capable of realizing a game progression and/or game mechanics that sufficiently gives novel stimulation and excitement to a player. Furthermore, by introducing a new index of the probability with which the game feature is provided, the gaming machine 10 can encourage the player to think strategically when selecting a free game.

As shown in FIGS. 17-41, in some embodiments, the one or more processors of the CPU 38 are programmed to execute algorithm 200 to display an animated sequence of computer-generated images of the computer-animated reel game 202 on the graphical user interface (GUI) of display device 16. For example, the CPU 38 is programmed to render the game screen on the display device GUI 16 including the grid 68 having a plurality of cells 70 arranged in a three row by five column (3x5) matrix, and render the plurality of reels 72-80 within the grid 68 displaying the plurality of game symbols 84 including a trigger symbol 85 and a special symbol 87, with each reel 72-80 being displayed within a corresponding column.

The CPU 38 then initiates a spin of the reel game by animating the plurality of reels 72-80 to spin and stop to display the game symbols 84 within the grid 68 including a plurality of trigger symbols 85. Upon detecting the trigger symbols 85 being displayed within the grid 68 with the reels 72-80 stopped, the CPU 38 then initiates the free game selection animation sequence 204 by determining a number of free games 214 based on the number of trigger symbols 85 being displayed within the grid 68 with the reels 72-80 stopped, and then accessing the super free game data lookup table 212 to determine a number of super free games 216 associated with the determined number of free games 214. For example, the super free game data lookup table 212 includes a plurality of free game data files 218. Each free game data file 218 includes a number of super free games corresponding to a range of free games. The CPU 38 accesses the super free game data lookup table 212 to determine the number of super free games 216 by selecting the free game data file 218 having the range of free games that includes the determined number of free games 214. If the selected free game data file 218 includes a range of super free games, the CPU 38 then randomly selects the number of super free games 216 from the range of super free games included in the selected free game data file 218 using the random number generator 108.

Upon determining the number of super free games 216 associated with the determined number of free games 214, the CPU 38 then renders a free game selection screen 220 on the display device GUI 16 that includes a player selectable free game icon 222 and a player selectable super free game icon 224. For example, the CPU 38 may render the free game selection screen 220 displaying the player selectable free game icon 222 and the player selectable super free game icon 224 overlaying the grid 68 and reels 72-80. The CPU 38 may also render a total free game icon 226 to appear on the game screen overlaying the grid 68 and reels 72-80 prior to rendering the free game selection screen 220 to indicate the determined number of free games 214 to the player.

The CPU 38 renders the player selectable free game icon 222 displaying the determined number of free games 214 and a first game feature notification icon 228 indicating that an appearance of the special symbol 87 may trigger the reveal boost game feature animation sequence 208. The CPU 38 also renders the player selectable super free game icon 224 displaying the determined number of super free games 216, an inner symbol notification icon 230 indicating that a predefined number of inner symbols 89 will be added to the reels 72-80, and a second game feature notification icon 232 indicating that an appearance of the special symbol 87 always triggers the reveal boost game feature animation sequence 208.

Upon detecting a player’s selection of the player selectable super free game icon 224, the CPU 38 animates the super free game icon 224 to increase in size while simultaneously decreasing the size of the free game icon 222 to indicate the player’s selection of the super free game icon 224 and then initiates the super free game animation sequence 206 by removing the player selectable free game icon 222 and the player selectable super free game icon 224 from the game screen and animating the plurality of reels 72-80 to spin through the grid 68, animating a plurality of inner symbols 89 to cascade downward from a top portion of the game screen onto the grid 68 as the plurality of reels 72-80 are spinning, and modifying the plurality of reels 72-80 to include the predefined number of inner symbols 89 as the plurality of reels 72-80 are spinning. The CPU 38 then animates the modified plurality of reels 72-80 to stop to display one or more inner symbols 89 and the special symbol 87 within the grid 68, randomly selects a game symbol 84 to replace the inner symbols 89 being displayed in the grid 68 with the reels stopped and animates each inner symbol 89 to reveal the randomly selected game symbol 84. For example, the CPU 38 may animate each inner symbol 89 to appear as a sliding double door 234 that is opened to reveal the randomly selected game symbol 84.

The CPU 38 then detects the appearance of the special symbol 87 being displayed in the grid 68 with the reels 72-80 stopped, and automatically initiates the reveal boost game feature animation sequence 208 upon detecting the appearance of the special symbol 87 by animating a second plurality of inner symbols 89 to cascade downward from the top portion of the game screen onto the grid and occupy each cell 70 not occupied by the special symbol 87 and then animating each inner symbol 89 to reveal the randomly selected game symbol 84. The CPU 38 then renders a celebration animation 236 onto the game screen overlaying the plurality of reels 72-80.

Upon detecting a player’s selection of the player selectable free game icon 222, the CPU 38 animates the free game icon 222 to increase in size to increase in size while simultaneously decreasing the size of the super free game icon 224 to indicate the player’s selection of the free game icon 222 and then initiates the free game animation sequence 210 by removing the player selectable free game icon 222 and the player selectable super free game icon 224 from the game screen and animating the plurality of reels 72-80 to spin through the grid 68. The CPU 38 then animates the plurality of reels 72-80 to stop and display the game symbol 84 including the special symbol 87 within the grid 68. Upon detecting the appearance of the special symbol 87 being displayed in the grid 68 with the reels 72-80 stopped, the CPU 38 then randomly determines whether to initiate the reveal boost game feature animation sequence 208 using he random number generator 108.

If the CPU 38 randomly determines to initiate the reveal boost game feature animation sequence 208, the CPU 38 then initiates the reveal boost game feature animation sequence 208 by randomly selecting a plurality of cells 70 within the grid 68 that are not occupied by the special symbol 87 using the random number generator 108 and animates a plurality of inner symbols 89 to cascade downward from the top portion of the game screen onto the grid 68 and occupy each randomly selected cell 70. The CPU 38 then randomly selects a game symbol 84 to replace the inner symbols 89 being displayed in the grid 68 using the random number generator 108 and animates each inner symbol 89 to reveal the randomly selected game symbol 84. The CPU 38 then renders the celebration animation 236 onto the game screen.

The gaming machine 10 may be a client computing device, in which case the game is delivered from a network-server computer system to one or more client computing devices via a communication network. The processor of the client computing device may be programmed to function as the control unit 22 of the gaming machine 10.

When the gaming machine 10 is used as a client computing device, (1) a rich client system may be used in which most of the processing involved in game execution is performed on the client side and results are transmitted to the server, (2) a thin-client system may be used in which only minimum processing is performed on the client side and main processing is performed on the server side, and (3) a zero client system may be used in which most of data storage and processing is performed on the server side and the client specializes in input and output. In this case, the software configuration described in the embodiment is distributed and implemented in the client and the server.

In the gaming machine 10 described above, an example in which the player selects between a free game and a super free game has been described, but the control unit 22 may select it with a certain probability without the player's selection. In the gaming machine 10 described above, the probability with which the game feature is provided in the base game (the first range in step S20) and the probability with which the game feature is provided in the free game (the first range in step S58) do not need to be the same, and different values may be set.

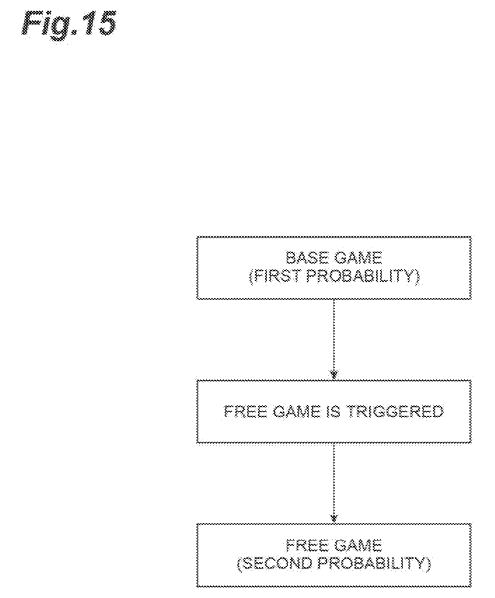

In the gaming machine 10 described above, a case has been described in which there is a gradient in the activation probability of the game feature when providing a same or corresponding game feature in the free game and the super free game, but this can also be applied to a case where a same or corresponding game feature is provided in the base game and the free game. FIG. 15 is a diagram illustrating a relationship between a base game and a free game. As shown in FIG. 15, a free game is triggered in a base game in which a game feature is provided with a first probability. This free game has a same or corresponding game feature as the base game, and the game feature is provided with a second probability higher than the first probability. In this case, since the same or corresponding game feature as the base game is provided at a higher probability in the free game than in the base game, the player's expectation for the free game can be improved.

The function of the control unit 22 of the gaming machine 10 described above can also be realized by executing a program by a computer. That is, it is possible to create a program that causes one or more computers to function in the same manner as the control unit 22 described above. The program may be provided by being recorded in a computer-readable recording medium such as a ROM or a semiconductor memory. Such a program may be divided into a plurality of modules.

Additionally, various modifications can be made to the operation in each embodiment. For instance, a mode could be adopted where a necessary number of random numbers are acquired in advance to determine the reel stop positions. Once the winning of the special game and the determination of the presence or absence of winning are completed, the contents are sequentially displayed on the display. Moreover, for instance, the control unit 22 could collectively acquire a necessary number of random numbers at the start of the game. Each random number could then be stored in a storage area of the memory 42 or the storage 44, which is not erased even when there's a power failure. In this scenario, even if a power failure or similar event occurs during the game, the control unit 22 can reproduce the game's progress. This is done by acquiring the random number, which was obtained at the start of the game before the power failure, from the memory 42 or the storage 44 when resuming the game after power restoration. For instance, if a power supply abnormality occurs just before the formation of a game result in which a high payout is obtained, a problem could arise if the same game doesn't proceed after power restoration. However, by collectively acquiring all random numbers at the start of the game and storing these numbers in the memory 42 or the storage 44 as described above, it's possible to reproduce the game's progress similar to that before the power source abnormality occurred, after power recovery. This way, such a problem can be avoided.

Additionally, in the described embodiment, a bill or a ticket represents the game value. The bill or ticket is received by the bill/ticket identification unit, and the ticket is output by the printer unit. However, the present disclosure is not limited to this setup. The game value concept includes tangible objects like coins, bills, medals, or tickets, as well as electronic data such as virtual credits or virtual currencies with equivalent value. For instance, a coin acceptor could accept coins and dispense coins from a coin hopper. One mode could involve identifying a player and using credits accumulated in a server account, with credits being paid out to the account. Alternatively, a mode could be adopted where credit information recorded on a storage medium like a magnetic card or an IC card is read and used, with credits being paid out by writing the information back to the storage medium. Furthermore, credits could be electronically transferred to and from a smartphone or a wearable device.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A gaming machine for displaying a computer-animated reel game, comprising:
a gaming cabinet;
a display device mounted to the gaming cabinet and including a graphical user interface (GUI) display screen displaying computer-generated images thereon; and
a control unit operably coupled to the display device and including a random number generator and one or more processors programmed to execute an algorithm to display an animated sequence of computer-generated images of the computer-animated reel game on the display device GUI including the steps of:
rendering a game screen on the display device GUI including a grid having a plurality of cells arranged in a three row by five column (3x5) matrix;
rendering a plurality of reels within the grid displaying a plurality of game symbols including a trigger symbol and a special symbol, each reel being displayed within a corresponding column;
initiating a spin of the reel game by animating the plurality of reels to spin and stop to display the game symbols within the grid including a plurality of trigger symbols; and
initiating a free game selection animation sequence by:
determining a number of free games based on a number of trigger symbols being displayed within the grid with the reels stopped;
accessing a super free game data lookup table to determine a number of super free games associated with the determined number of free games; and
rendering a free game selection screen including a player selectable free game icon and a player selectable super free game icon;
wherein the player selectable free game icon displays the determined number of free games and a first game feature notification icon indicating that an appearance of the special symbol may trigger a reveal boost game feature animation sequence; and
wherein the player selectable super free game icon displays the determined number of super free games, an inner symbol notification indicating that a predefined number of inner symbols will be added to the reels, and a second game feature notification icon indicating that an appearance of the special symbol always triggers the reveal boost game feature animation sequence.

2. The gaming machine of claim 1, wherein the one or more processors is programmed to execute the algorithm including the steps of:
initiating a super free game animation sequence upon detecting a player’s selection of the player selectable super free game icon by:
animating the plurality of reels to spin through the grid;
animating a plurality of inner symbols to cascade downward from a top portion of the game screen onto the grid as the plurality of reels are spinning and modifying the plurality of reels to include the predefined number of inner symbols as the plurality of reels are spinning; and
animating the modified plurality of reels to stop to display one or more inner symbols and the special symbol.

3. The gaming machine of claim 2, wherein the one or more processors is programmed to execute the algorithm including the steps of:
randomly selecting a game symbol to replace the inner symbols being displayed in the grid with the reels stopped; and
animating each inner symbol to reveal the randomly selected game symbol.

4. The gaming machine of claim 3, wherein the one or more processors is programmed to execute the algorithm including the steps of:
detecting the appearance of the special symbol being displayed in the grid with the reels stopped; and
automatically initiating the reveal boost game feature animation sequence upon detecting the appearance of the special symbol by:
animating a second plurality of inner symbols to cascade downward from the top portion of the game screen onto the grid and occupy each cell not occupied by the special symbol; and
animating each inner symbol to reveal the randomly selected game symbol.

5. The gaming machine of claim 1, wherein the one or more processors is programmed to execute the algorithm including the steps of:
initiating a free game animation sequence upon detecting a player’s selection of the player selectable free game icon by:
animating the plurality of reels to spin through the grid;
animating the plurality of reels to stop and display the special symbol within the grid;
randomly determining whether to initiate the reveal boost game feature animation sequence using a random number generator; and
upon determining to initiate the reveal boost game feature animation sequence, initiate the reveal boost game feature animation sequence by:
randomly selecting a plurality of cells within the grid not occupied by the special symbol;
animating a plurality of inner symbols to cascade downward from the top portion of the game screen onto the grid and occupy each randomly selected cell;
randomly selecting a game symbol to replace the inner symbols being displayed in the grid; and
animating each inner symbol to reveal the randomly selected game symbol.

6. The gaming machine of claim 5, wherein the one or more processors is programmed to execute the algorithm including the steps of:
animating the player selected free game icon to increase in size upon receiving the player’s selection of the player selectable free game icon to indicate the player’s selection of the player selectable free game icon.

7. The gaming machine of claim 1, wherein the one or more processors is programmed to execute the algorithm including the steps of:
displaying a total free game icon on the game screen prior to rendering the free game selection screen to indicate the determined number of free games.

8. A method of operating a gaming machine for displaying a computer-animated reel game, the gaming machine including a gaming cabinet, a display device mounted to the cabinet and including a graphical user interface (GUI) display screen displaying computer-generated images thereon, and a control unit including a random number generator and one or more processors coupled to the display device, the method including the one or more processors performing an algorithm to display an animated sequence of computer-generated images of the computer-animated reel game on the display device GUI including the steps of:
rendering a game screen on the display device GUI including a grid having a plurality of cells arranged in a three row by five column (3x5) matrix;
rendering a plurality of reels within the grid displaying a plurality of game symbols including a trigger symbol and a special symbol, each reel being displayed within a corresponding column;
initiating a spin of the reel game by animating the plurality of reels to spin and stop to display the game symbols within the grid including a plurality of trigger symbols; and
initiating a free game selection animation sequence by:
determining a number of free games based on a number of trigger symbols being displayed within the grid with the reels stopped;
accessing a super free game data lookup table to determine a number of super free games associated with the determined number of free games; and
rendering a free game selection screen including a player selectable free game icon and a player selectable super free game icon;
wherein the player selectable free game icon displays the determined number of free games and a first game feature notification icon indicating that an appearance of the special symbol may trigger a reveal boost game feature animation sequence; and
wherein the player selectable super free game icon displays the determined number of super free games, an inner symbol notification indicating that a predefined number of inner symbols will be added to the reels, and a second game feature notification icon indicating that an appearance of the special symbol always triggers the reveal boost game feature animation sequence.

9. The method of claim 8, including the one or more processors performing the algorithm including the steps of:
initiating a super free game animation sequence upon detecting a player’s selection of the player selectable super free game icon by:
animating the plurality of reels to spin through the grid;
animating a plurality of inner symbols to cascade downward from a top portion of the game screen onto the grid as the plurality of reels are spinning and modifying the plurality of reels to include the predefined number of inner symbols as the plurality of reels are spinning; and
animating the modified plurality of reels to stop to display one or more inner symbols and the special symbol.

10. The method of claim 9, including the one or more processors performing the algorithm including the steps of:
randomly selecting a game symbol to replace the inner symbols being displayed in the grid with the reels stopped; and
animating each inner symbol to reveal the randomly selected game symbol.

11. The method of claim 10, including the one or more processors performing the algorithm including the steps of:
detecting the appearance of the special symbol being displayed in the grid with the reels stopped; and
automatically initiating the reveal boost game feature animation sequence upon detecting the appearance of the special symbol by:
animating a second plurality of inner symbols to cascade downward from the top portion of the game screen onto the grid and occupy each cell not occupied by the special symbol; and
animating each inner symbol to reveal the randomly selected game symbol.

12. The method of claim 8, including the one or more processors performing the algorithm including the steps of:
initiating a free game animation sequence upon detecting a player’s selection of the player selectable free game icon by:
animating the plurality of reels to spin through the grid;
animating the plurality of reels to stop and display the special symbol within the grid;
randomly determining whether to initiate the reveal boost game feature animation sequence using a random number generator; and
upon determining to initiate the reveal boost game feature animation sequence, initiate the reveal boost game feature animation sequence by:
randomly selecting a plurality of cells within the grid not occupied by the special symbol;
animating a plurality of inner symbols to cascade downward from the top portion of the game screen onto the grid and occupy each randomly selected cell;
randomly selecting a game symbol to replace the inner symbols being displayed in the grid; and
animating each inner symbol to reveal the randomly selected game symbol.

13. The method of claim 12, including the one or more processors performing the algorithm including the steps of:
animating the player selected free game icon to increase in size upon receiving the player’s selection of the player selectable free game icon to indicate the player’s selection of the player selectable free game icon.

14. The method of claim 8, including the one or more processors performing the algorithm including the steps of:
displaying a total free game icon on the game screen prior to rendering the free game selection screen to indicate the determined number of free games.

15. A non-transitory computer-readable storage media having computer-executable instructions embodied thereon to operate a gaming machine for displaying a computer-animated reel game, the gaming machine including a gaming cabinet, a display device mounted to the cabinet and including a graphical user interface (GUI) display screen displaying computer-generated images thereon, and a control unit including a random number generator and one or more processors coupled to the display device, when executed by the one or more processors the computer-executable instructions cause the one or more processors to perform an algorithm to display an animated sequence of computer-generated images of the computer-animated reel game on the display device GUI including the steps of:
rendering a game screen on the display device GUI including a grid having a plurality of cells arranged in a three row by five column (3x5) matrix;
rendering a plurality of reels within the grid displaying a plurality of game symbols including a trigger symbol and a special symbol, each reel being displayed within a corresponding column;
initiating a spin of the reel game by animating the plurality of reels to spin and stop to display the game symbols within the grid including a plurality of trigger symbols; and
initiating a free game selection animation sequence by:
determining a number of free games based on a number of trigger symbols being displayed within the grid with the reels stopped;
accessing a super free game data lookup table to determine a number of super free games associated with the determined number of free games; and
rendering a free game selection screen including a player selectable free game icon and a player selectable super free game icon;
wherein the player selectable free game icon displays the determined number of free games and a first game feature notification icon indicating that an appearance of the special symbol may trigger a reveal boost game feature animation sequence; and
wherein the player selectable super free game icon displays the determined number of super free games, an inner symbol notification indicating that a predefined number of inner symbols will be added to the reels, and a second game feature notification icon indicating that an appearance of the special symbol always triggers the reveal boost game feature animation sequence.

16. The non-transitory computer-readable storage media of claim 15, wherein the computer-executable instructions cause the one or more processors to perform the algorithm including the steps of:
initiating a super free game animation sequence upon detecting a player’s selection of the player selectable super free game icon by:
animating the plurality of reels to spin through the grid;
animating a plurality of inner symbols to cascade downward from a top portion of the game screen onto the grid as the plurality of reels are spinning and modifying the plurality of reels to include the predefined number of inner symbols as the plurality of reels are spinning; and
animating the modified plurality of reels to stop to display one or more inner symbols and the special symbol.

17. The non-transitory computer-readable storage media of claim 16, wherein the computer-executable instructions cause the one or more processors to perform the algorithm including the steps of:
randomly selecting a game symbol to replace the inner symbols being displayed in the grid with the reels stopped; and
animating each inner symbol to reveal the randomly selected game symbol.

18. The non-transitory computer-readable storage media of claim 17, wherein the computer-executable instructions cause the one or more processors to perform the algorithm including the steps of:
detecting the appearance of the special symbol being displayed in the grid with the reels stopped; and
automatically initiating the reveal boost game feature animation sequence upon detecting the appearance of the special symbol by:
animating a second plurality of inner symbols to cascade downward from the top portion of the game screen onto the grid and occupy each cell not occupied by the special symbol; and
animating each inner symbol to reveal the randomly selected game symbol.

19. The non-transitory computer-readable storage media of claim 15, wherein the computer-executable instructions cause the one or more processors to perform the algorithm including the steps of:
initiating a free game animation sequence upon detecting a player’s selection of the player selectable free game icon by:
animating the plurality of reels to spin through the grid;
animating the plurality of reels to stop and display the special symbol within the grid;
randomly determining whether to initiate the reveal boost game feature animation sequence using a random number generator; and
upon determining to initiate the reveal boost game feature animation sequence, initiate the reveal boost game feature animation sequence by:
randomly selecting a plurality of cells within the grid not occupied by the special symbol;
animating a plurality of inner symbols to cascade downward from the top portion of the game screen onto the grid and occupy each randomly selected cell;
randomly selecting a game symbol to replace the inner symbols being displayed in the grid; and
animating each inner symbol to reveal the randomly selected game symbol.

20. The non-transitory computer-readable storage media of claim 15, wherein the computer-executable instructions cause the one or more processors to perform the algorithm including the steps of:
displaying a total free game icon on the game screen prior to rendering the free game selection screen to indicate the determined number of free games.
